(19) United States
(12) Patent Application Publication
(10) Pub. No.: US 2004/0145599 A1
(43) Pub. Date: Jul. 29, 2004

(54) Display apparatus, method and program

(76) Inventors: Hiroki Taoka, Yodogawa-ku (JP); Tadanori Tezuka, Kaho-gun (JP)

Correspondence Address: Joseph W. Price, SNELL & WILMER L.L.P., Suite 1200, 1920 Main Street, Irvine, CA, 92614-7230, US

(21) Appl. No.: 10/715,675

(22) Filed: Nov. 18, 2003

(30) Foreign Application Priority Data
Nov. 27, 2002 (JP) 2002-344020

(51) Int. Cl. G09G 5/02

(52) U.S. Cl. 345/698

(57) ABSTRACT

A display apparatus that displays a composite image of a front image and a back image. The display apparatus includes: a front-image change detecting unit 42 that detects a difference in a visual characteristic between a sub-pixel and the surrounding sub-pixels in a front image; a filtering necessity judging unit 43 that judges for each sub-pixel in the front image whether a sub-pixel should be subject to the filtering process or not, based on the degree of the detected difference; and a filtering unit 45 that performs the filtering process only on sub-pixels in the composite image that correspond to the sub-pixels that have been judged as having to be subject to the filtering process.

### BACKGROUND OF THE INVENTION

(1) Field of the Invention

The present invention relates to a technology for displaying high-quality images on a display device which includes a plurality of pixels each of which is an alignment of three luminous elements for three primary colors.

(2) Description of the Related Art

Among various types of display apparatuses, there are some types, such as LCD (Liquid Crystal Display) or PDP (Plasma Display Panel), that include a display device having a plurality of pixels each of which is an alignment of three luminous elements for three primary colors R, G and B (red, green and blue), where the pixels are aligned to form a plurality of lines, and the luminous elements are called sub-pixels.

In general, images are displayed in units of pixels. However, when images are displayed in units of pixels on a small-sized, low-resolution screen of, for example, a mobile telephone or a mobile computer, oblique lines in characters, photographs or complicated drawings look shaggy.

Technologies for displaying images in units of sub-pixels with the intention of solving the above problem are disclosed in (a) a research paper “Sub-Pixel Font Rendering Technology” (hereinafter referred to as a non-patent document 1) published in the address “http://grc.com/cleartype.htm” in the Internet and (b) WO 00/42762 (hereinafter referred to as a patent document 1).

When images are displayed in units of sub-pixels, with three sub-pixels for primary colors aligned in each pixel in the lengthwise direction of the lines of pixels (hereinafter referred to as a first direction), a pixel having a color greatly different from adjacent pixels in the first direction (that is, a pixel at an edge of an image) causes a color drift to be observed by the viewers. This is because any sub-pixel in the prominent-color pixel is greatly different from the adjacent sub-pixels in luminance. For this reason, to provide a high-quality display in units of sub-pixels, the image data needs to be filtered so that such prominent color values are smoothed out.

[Patent Document 1]:

WO 00/42762 (page 25, FIGS. 11 and 13)

[Non-Patent Document 1]:

“Sub-Pixel Font Rendering Technology”, [online], Feb. 20, 2000, Gibson Research Corporation, [retrieved on Jun. 19, 2000], Internet <URL: http://grc.com/cleartype.htm>

However, when the sub-pixels are smoothed-out in luminance, the image become dim. This is another problem of image deterioration. Here, when a front image is superimposed on a back image that has been subject to a filtering (smoothing-out) process, the effect of the filtering on the back image is doubled at areas where the superimposed front image have high degrees of transparency. Also, the smoothing out of luminance is performed each time another front image is superimposed on the composite image.

The more the superimposition of an image or the filtering is performed on a same image, the more degraded the image quality is. This is because the effect of the filtering (smoothing-out) on the image is accumulated and becomes more noticeable with the repetition.

As described above, display apparatuses for displaying high-quality images in units of sub-pixels have a problem of image quality degradation that becomes prominent when sub-pixel luminance is smoothed out a plurality of times.

### SUMMARY OF THE INVENTION

The object of the present invention is therefore to provide a display apparatus, a display method, and a display program that remove the color drifts by smoothing out the luminance of the composite image and at the same time preventing the image quality from being deteriorated by reducing the amount of accumulated smooth-out effect, thus achieving high-quality images displayed in units of sub-pixels.

The above object is fulfilled by a display apparatus for displaying an image on a display device which includes rows of pixels, each pixel composed of three sub-pixels that align in a lengthwise direction of the pixel rows and emit light of three primary colors respectively, the display apparatus comprising: a front image storage unit operable to store color values of sub-pixels that constitute a front image to be displayed on the display device; a calculation unit operable to calculate a dissimilarity level of a target sub-pixel to one or more sub-pixels that are adjacent to the target sub-pixel in the lengthwise direction of the pixel rows, from color values of first-target-range sub-pixels composed of the target sub-pixel and the one or more adjacent sub-pixels stored in the front image storage unit; a superimposing unit operable to generate, from color values of the front image stored in the front image storage unit and color values of an image currently displayed on the display device, color values of sub-pixels constituting a composite image of the front image and the currently displayed image; a filtering unit operable to smooth out color values of second-target-range sub-pixels of the composite image that correspond to the first-target-range sub-pixels, by assigning weights, which are determined in accordance with the dissimilarity level, to the second-target-range sub-pixels; and a displaying unit operable to display the composite image based on the color values thereof after the smoothing out.

With the above-stated construction, the display apparatus performs the filtering process with a higher degree of smooth-out effect on an area in the front image that is different in color from adjacent areas to a greater extent in the front image and expected to cause a color drift in the composite image to be observed by the viewer, and performs the filtering process with a lower degree of smooth-out effect on an area in the front image that is different in color from adjacent areas to a lesser extent and expected to hardly cause a color drift.

This prevents a color drift from occurring by effectively performing a filtering on an area having a prominent color value, and at the same time preventing image quality deterioration due to accumulation of the smooth-out effect, thus providing a high-quality image display with the accuracy of sub-pixel.

In the above display apparatus, the calculation unit may calculate a temporary dissimilarity level for each combination of the first-target-range sub-pixels, from color values of the first-target-range sub-pixels, and regards a largest temporary dissimilarity level among results of the calculation to be the dissimilarity level.

With the above-stated construction, the display apparatus performs the filtering process with a high degree of smooth-out effect on the target sub-pixel in the composite image even if the dissimilarity level of the target sub-pixel to the adjacent sub-pixels in the first-target-range sub-pixels is lower than a dissimilarity level between sub-pixels other than the target sub-pixel in the first-target-range sub-pixels.

This prevents a color drift from occurring due to a drastic change in the degree of smooth-out effect provided by the filtering process to adjacent sub-pixels.

In the above display apparatus, the first-target-range sub-pixels and the second-target-range sub-pixels may be identical with each other in number and positions in the display device.

With the above-stated construction, (a) a smooth-out is performed on sub-pixels in the composite image that are identical, in number and positions in the display device, with the sub-pixels in the front image from whose color values a dissimilarity level is calculated, and (b) the degree of the smooth-out is determined based on the dissimilarity level. This enables the filtering process to be performed accurately.

This prevents the degree of smooth-out effect by the filtering process from drastically changing between adjacent sub-pixels.

In the above display apparatus, the filtering unit may perform the smoothing out of the second-target-range sub-pixels if the dissimilarity level calculated by the calculation unit is greater than a predetermined threshold value, and may not perform the smoothing out if the calculated dissimilarity level is no greater than the predetermined threshold value.

With the above-stated construction, the display apparatus performs the filtering process only on such an area as is expected to cause a color drift in the composite image.

This reduces the area on which the filtering is performed redundantly in the composite image.

The above object is also fulfilled by a display apparatus for displaying an image on a display device which includes rows of pixels, each pixel composed of three sub-pixels that align in a lengthwise direction of the pixel rows and emit light of three primary colors respectively, the display apparatus comprising: a front image storage unit operable to store color values and transparency values of sub-pixels that constitute a front image to be displayed on the display device, where the transparency values indicate degrees of transparency of sub-pixels of the front image when the front image is superimposed on an image currently displayed on the display device; a calculation unit operable to calculate a dissimilarity level of a target sub-pixel to one or more sub-pixels that are adjacent to the target sub-pixel in the lengthwise direction of the pixel rows, from at least one of (i) color values and (ii) transparency values of first-target-range sub-pixels composed of the target sub-pixel and the one or more adjacent sub-pixels stored in the front image storage unit; a superimposing unit operable to generate, from color values of the front image stored in the front image storage unit and color values of the image currently displayed on the display device, color values of sub-pixels constituting a composite image of the front image and the currently displayed image; a filtering unit operable to smooth out color values of second-target-range sub-pixels of the composite image that correspond to the first-target-range sub-pixels, by assigning weights, which are determined in accordance with the dissimilarity level, to the second-target-range sub-pixels; and a displaying unit operable to display the composite image based on the color values thereof after the smoothing out.

With the above-stated construction, the display apparatus performs the filtering process with a higher degree of smooth-out effect on an area in the front image that is different in color or degree of transparency from adjacent areas to a greater extent in the front image and expected to cause a color drift in the composite image to be observed by the viewer, and performs the filtering process with a lower degree of smooth-out effect on an area in the front image that is different in color or degree of transparency from adjacent areas to a lesser extent and expected to hardly cause a color drift.

This prevents a color drift from occurring by effectively performing a filtering on an area having a prominent color value, and at the same time preventing image quality deterioration due to accumulation of the smooth-out effect, thus providing a high-quality image display with the accuracy of sub-pixel.

In the above display apparatus, the calculation unit may calculate a temporary dissimilarity level for each combination of the first-target-range sub-pixels, from at least one of (i) color values and (ii) transparency values of the first-target-range sub-pixels, and regards a largest temporary dissimilarity level among results of the calculation to be the dissimilarity level.

With the above-stated construction, the display apparatus performs the filtering process with a high degree of smooth-out effect on the target sub-pixel in the composite image even if the dissimilarity level of the target sub-pixel to the adjacent sub-pixels in the first-target-range sub-pixels is lower than a dissimilarity level between sub-pixels other than the target sub-pixel in the first-target-range sub-pixels.

This prevents a color drift from occurring due to a drastic change in the degree of smooth-out effect provided by the filtering process to adjacent sub-pixels.

In the above display apparatus, the first-target-range sub-pixels and the second-target-range sub-pixels may be identical with each other in number and positions in the display device.

With the above-stated construction, the degree of smooth-out to be performed on sub-pixels in the composite image is determined based on a dissimilarity level that has been calculated from color values of sub-pixels in the front image that are identical, in number and positions in the display device, with the sub-pixels in the composite image on which the smooth-out is performed. This enables the filtering process to be performed accurately.

In the above display apparatus, the filtering unit may perform the smoothing out of the second-target-range sub-pixels if the dissimilarity level calculated by the calculation unit is greater than a predetermined threshold value, and may not perform the smoothing out if the calculated dissimilarity level is no greater than the predetermined threshold value.

With the above-stated construction, the display apparatus performs the filtering process only on such an area as is expected to cause a color drift in the composite image.

This reduces the area on which the filtering is performed redundantly in the composite image.

The above object is also fulfilled by a display method for displaying an image on a display device which includes rows of pixels, each pixel composed of three sub-pixels that align in a lengthwise direction of the pixel rows and emit light of three primary colors respectively, the display method comprising: a front image acquiring step for acquiring color values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device; a calculation step for calculating a dissimilarity level of the target sub-pixel to the one or more sub-pixels, from the color values of the first-target-range sub-pixels acquired in the front image acquiring step; a superimposing step for generating, from the color values of the front image acquired in the front image acquiring step and color values of an image currently displayed on the display device, color values of sub-pixels constituting a composite image of the front image and the currently displayed image; a filtering step for smoothing out color values of second-target-range sub-pixels of the composite image that correspond to the first-target-range sub-pixels, by assigning weights, which are determined in accordance with the dissimilarity level, to the second-target-range sub-pixels; and a displaying step for displaying the composite image based on the color values thereof after the smoothing out.

With the above-stated construction, the display apparatus performs the filtering process with a higher degree of smooth-out effect on an area in the front image that is different in color from adjacent areas to a greater extent in the front image and expected to cause a color drift in the composite image to be observed by the viewer, and performs the filtering process with a lower degree of smooth-out effect on an area in the front image that is different in color from adjacent areas to a lesser extent and expected to hardly cause a color drift.

This prevents a color drift from occurring by effectively performing a filtering on an area having a prominent color value, and at the same time preventing image quality deterioration due to accumulation of the smooth-out effect, thus providing a high-quality image display with the accuracy of sub-pixel.

The above object is also fulfilled by a display method for displaying an image on a display device which includes rows of pixels, each pixel composed of three sub-pixels that align in a lengthwise direction of the pixel rows and emit light of three primary colors respectively, the display method comprising: a front image acquiring step for acquiring color values and transparency values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device, where the transparency values indicate degrees of transparency of sub-pixels of the front image when the front image is superimposed on an image currently displayed on the display device; a calculation step for calculating a dissimilarity level of the target sub-pixel to the one or more sub-pixels, from at least one of the (i) color values and (ii) transparency values of the first-target-range sub-pixels acquired in the front image acquiring step; a superimposing step for generating, from the color values of the front image acquired in the front image acquiring step and color values of the currently displayed image, color values of sub-pixels constituting a composite image of the front image and the currently displayed image; a filtering step for smoothing out color values of second-target-range sub-pixels of the composite image that correspond to the first-target-range sub-pixels, by assigning weights, which are determined in accordance with the dissimilarity level, to the second-target-range sub-pixels; and a displaying step for displaying the composite image based on the color values thereof after the smoothing out.

With the above-stated construction, the display apparatus performs the filtering process with a higher degree of smooth-out effect on an area in the front image that is different in color or degree of transparency from adjacent areas to a greater extent in the front image and expected to cause a color drift in the composite image to be observed by the viewer, and performs the filtering process with a lower degree of smooth-out effect on an area in the front image that is different in color or degree of transparency from adjacent areas to a lesser extent and expected to hardly cause a color drift.

This prevents a color drift from occurring by effectively performing a filtering on an area having a prominent color value, and at the same time preventing image quality deterioration due to accumulation of the smooth-out effect, thus providing a high-quality image display with the accuracy of sub-pixel.

The above object is also fulfilled by a display program for displaying an image on a display device which includes rows of pixels, each pixel composed of three sub-pixels that align in a lengthwise direction of the pixel rows and emit light of three primary colors respectively, the display program causing a computer to execute: a front image acquiring step for acquiring color values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device; a calculation step for calculating a dissimilarity level of the target sub-pixel to the one or more sub-pixels, from the color values of the first-target-range sub-pixels acquired in the front image acquiring step; a superimposing step for generating, from the color values of the front image acquired in the front image acquiring step and color values of an image currently displayed on the display device, color values of sub-pixels constituting a composite image of the front image and the currently displayed image; a filtering step for smoothing out color values of second-target-range sub-pixels of the composite image that correspond to the first-target-range sub-pixels, by assigning weights, which are determined in accordance with the dissimilarity level, to the second-target-range sub-pixels; and a displaying step for displaying the composite image based on the color values thereof after the smoothing out.

With the above-stated construction, the display apparatus performs the filtering process with a higher degree of smooth-out effect on an area in the front image that is different in color from adjacent areas to a greater extent in the front image and expected to cause a color drift in the composite image to be observed by the viewer, and performs the filtering process with a lower degree of smooth-out effect on an area in the front image that is different in color from adjacent areas to a lesser extent and expected to hardly cause a color drift.

This prevents a color drift from occurring by effectively performing a filtering on an area having a prominent color value, and at the same time preventing image quality deterioration due to accumulation of the smooth-out effect, thus providing a high-quality image display with the accuracy of sub-pixel.

The above object is also fulfilled by a display program for displaying an image on a display device which includes rows of pixels, each pixel composed of three sub-pixels that align in a lengthwise direction of the pixel rows and emit light of three primary colors respectively, the display program causing a computer to execute: a front image acquiring step for acquiring color values and transparency values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device, where the transparency values indicate degrees of transparency of sub-pixels of the front image when the front image is superimposed on an image currently displayed on the display device; a calculation step for calculating a dissimilarity level of the target sub-pixel to the one or more sub-pixels, from at least one of the (i) color values and (ii) transparency values of the first-target-range sub-pixels acquired in the front image acquiring step; a superimposing step for generating, from the color values of the front image acquired in the front image acquiring step and color values of the currently displayed image, color values of sub-pixels constituting a composite image of the front image and the currently displayed image; a filtering step for smoothing out color values of second-target-range sub-pixels of the composite image that correspond to the first-target-range sub-pixels, by assigning weights, which are determined in accordance with the dissimilarity level, to the second-target-range sub-pixels; and a displaying step for displaying the composite image based on the color values thereof after the smoothing out.

With the above-stated construction, the display apparatus performs the filtering process with a higher degree of smooth-out effect on an area in the front image that is different in color or degree of transparency from adjacent areas to a greater extent in the front image and expected to cause a color drift in the composite image to be observed by the viewer, and performs the filtering process with a lower degree of smooth-out effect on an area in the front image that is different in color or degree of transparency from adjacent areas to a lesser extent and expected to hardly cause a color drift.

This prevents a color drift from occurring by effectively performing a filtering on an area having a prominent color value, and at the same time preventing image quality deterioration due to accumulation of the smooth-out effect, thus providing a high-quality image display with the accuracy of sub-pixel.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the construction of the display apparatus 100 in Embodiment 1 of the present invention;

FIG. 2 shows the data structure of the front texture table 21 stored in the texture memory 3;

FIG. 3 shows the construction of the superimposing/sub-pixel processing unit 35;

FIG. 4 shows the construction of the front-image change detecting unit 42;

FIG. 5 shows the construction of the filtering unit 45;

FIG. 6 shows the construction of a superimposing/sub-pixel processing unit 36 for detecting a change in color in the front image using the luminance value and α value;

FIG. 7 shows the construction of the front-image change detecting unit 46;

FIG. 8 shows the construction of the filtering necessity judging unit 47;

FIG. 9 is a flowchart showing the operation procedures of the display apparatus 100 in Embodiment 1 of the present invention;

FIG. 10 is a flowchart showing the operation procedures of the display apparatus 100 in Embodiment 1 of the present invention;

FIG. 11 is a flowchart showing the operation procedures of the display apparatus 100 in Embodiment 1 of the present invention;

FIG. 12 shows an example of display images 103 and 104 respectively displayed on a conventional display apparatus and the display apparatus 100 in Embodiment 1 of the present invention;

FIG. 13 shows the construction of the display apparatus 200 in Embodiment 2 of the present invention;

FIG. 14 shows the construction of the superimposing/sub-pixel processing unit 37;

FIG. 15 shows the construction of the filtering coefficient determining unit 49;

FIG. 16 shows relationships between the dissimilarity level and the filtering coefficient;

FIG. 17 shows the construction of the filtering unit 50; and

FIG. 18 is a flowchart showing the operation procedures of the display apparatus 200 in Embodiment 2 of the present invention in generating a composite image and performing a filtering process on the composite image.

### DESCRIPTION OF THE PREFERRED EMBODIMENT

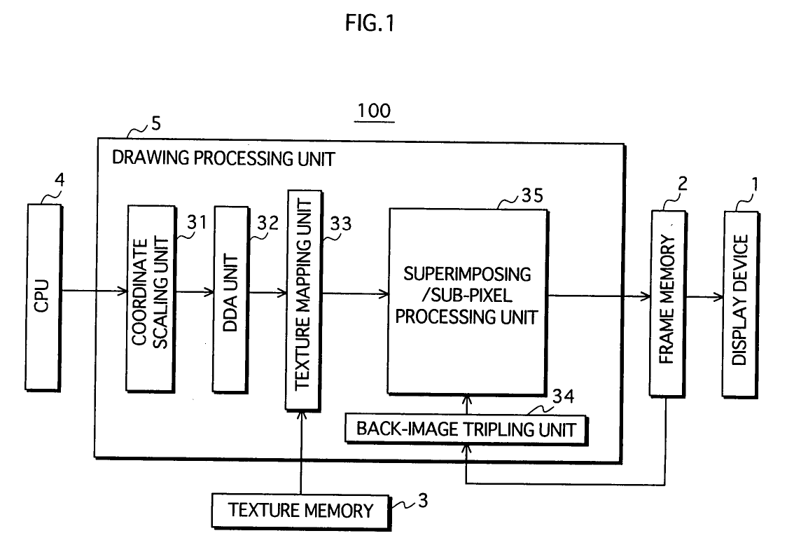

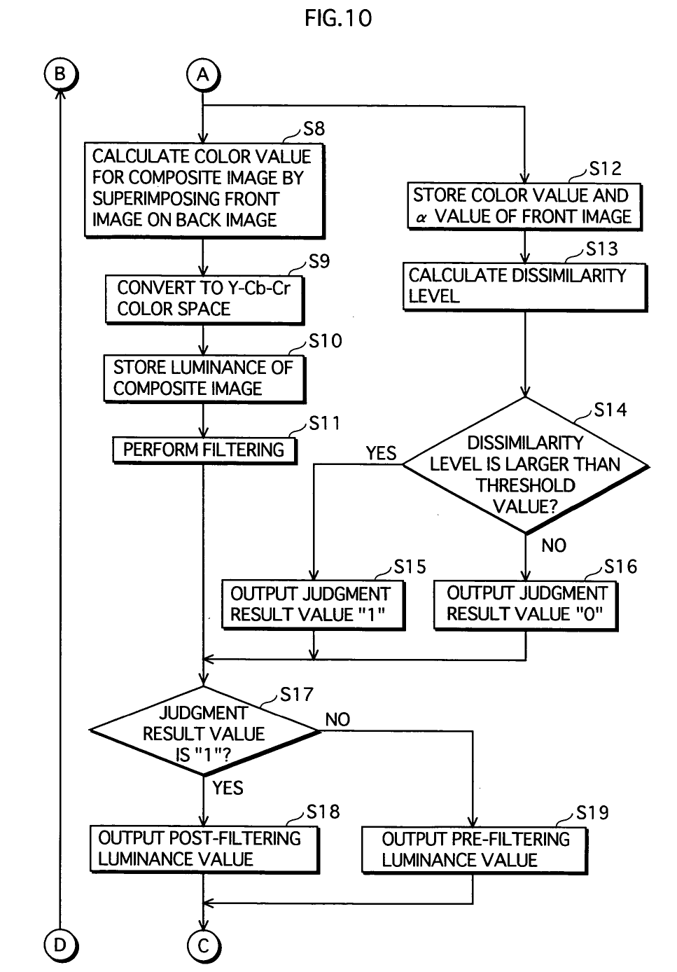

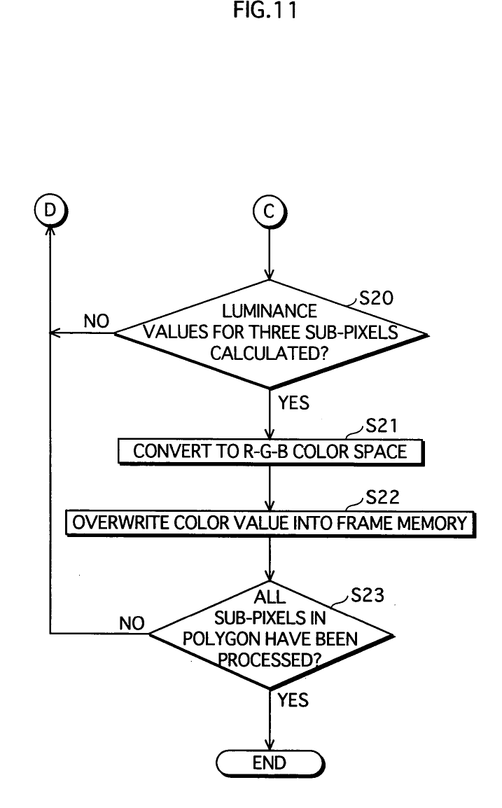

Some preferred embodiments of the present invention will be described with reference to the attached drawings, FIGS. 1-18.

Embodiment 1

General Outlines

A display apparatus 100 of Embodiment 1 superimposes a front image on a back image that has been subject to a filtering process in which the luminance is smoothed out to remove color drifts. The display apparatus 100 subjects the composite image to a filtering process in which only limited areas of the composite image are filtered, so that overlaps of filtering on the back image components of the composite image are prevented. The display apparatus 100 then displays the composite image in units of sub-pixels.

Construction

FIG. 1 shows the construction of the display apparatus 100 in Embodiment 1 of the present invention. The display apparatus 100, intended to display high-quality images by displaying the images in units of sub-pixels, includes a display device 1, a frame memory 2, a texture memory 3, a CPU 4, and a drawing processing unit 5.

The display device 1 includes a display screen (not illustrated) and a driver (not illustrated). The display screen is composed of a plurality of pixels each of which is an alignment of three luminous elements (also referred to as sub-pixels) for three primary colors R, G and B (red, green and blue), where the pixels are aligned to form a plurality of lines. Hereinafter, the lengthwise direction of the lines are referred to as a first direction and a direction perpendicular to the first direction is referred to as a second direction. In each pixel, the three sub-pixels are aligned in the first direction in the order of R, G and B. The driver reads detailed information of an image to be displayed from the frame memory 2 and displays the image on the display screen according to the read image information.

As described earlier, when images are displayed in units of sub-pixels, a pixel having a color greatly different from adjacent pixels in the first direction causes a color drift to be observed by the viewers. This is because any sub-pixel in the prominent-color pixel is greatly different from adjacent sub-pixels in luminance. For this reason, to provide a high-quality display in units of sub-pixels, the image data needs to be filtered so that such prominent luminance values are smoothed out.

In the filtering process in Embodiment 1, each luminance-prominent sub-pixel is smoothed out by distributing the luminance value of the target sub-pixel to four surrounding sub-pixels, or by receiving excess luminance values from the surrounding sub-pixels, the four surrounding sub-pixels being composed of two sub-pixels before and two sub-pixels after the target sub-pixel in the first direction.

The frame memory 2 is a semiconductor memory to store detailed information of an image to be displayed on the display screen. The image information stored in the frame memory 2 includes color values of the three primary colors R, G and B for each pixel constituting the image to be displayed on the screen, in correspondence to each pixel constituting the display screen. It should be noted here that the image information stored in the frame memory 2 is information of an image that has been subject to the filtering process and is ready to be displayed on the display screen.

It should be noted here that in Embodiment 1, each primary color R, G or B takes on color values from “0” to “1” inclusive. Each combination of color values for three primary colors of a pixel represents a color of the pixel. For example, a pixel composed of R=1, G=1, B=1 is white. Also, a pixel composed of R=0, G=0, B=0 is black.

The texture memory 3 is a memory to store a front texture table 21 which includes detailed information of a texture image that is mapped onto the front image. The information stored in the texture memory 3 includes color values of the sub-pixels constituting the texture image.

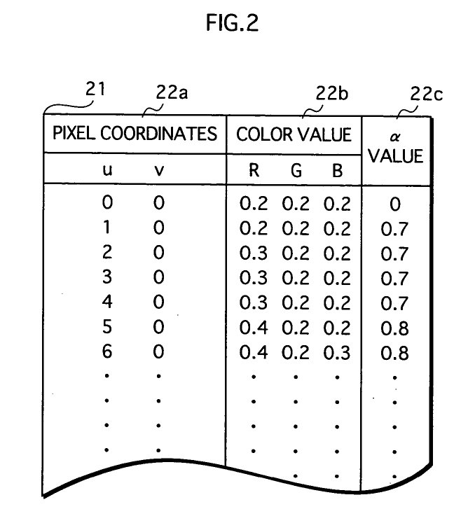

FIG. 2 shows the data structure of the front texture table 21 stored in the texture memory 3. As shown in FIG. 2, the front texture table 21 includes a pixel coordinates column 22a, a color value column 22b, and an α value column 22c. in the table, each row corresponds to a pixel, has respective values of the columns, and is referred to as a piece of pixel information. The front texture table 21 includes as many pieces of pixel information as the number of pixels constituting the texture images.

It should be noted here that the pixel coordinates column 22a includes u and v coordinate values assigned to the pixels constituting the texture image.

Also, in the present document, the α value, which takes on values from “0” to “1” inclusive, indicates a degree of transparency of a pixel of a front image when the front image is superimposed on a back image. More specifically, when the α value is “0”, the corresponding pixel of the front image becomes transparent, and the color values of the corresponding pixel in the back image are used as they are in the composite image; when the α value is “1”, the corresponding pixel of the front image becomes non-transparent, and the color values of the front-image pixel are used as they are in the composite image; and when the condition 0<α<1 is satisfied, weighted averages of the pixels of the front and back images are used in the composite image.

The CPU (Central Processing Unit) 4 provides the drawing processing unit 5 with apex information. The apex information is used when the texture image is mapped onto the front image. Each piece of apex information includes (i) display position coordinates (x,y) of an apex of a partial triangular area of the front image and (ii) texture image pixel coordinates (u,v) of a corresponding pixel in the texture image. The display position coordinates (x,y) are in a X-Y coordinate system composed of an X axis extending in the first direction and a Y axis extending in the second direction. Hereinafter, the partial triangular area of the front image indicated by three pieces of apex information is referred to as a polygon.

The drawing processing unit 5 reads image information from the frame memory 2 and the texture memory 3, and generate images to be displayed on the display device 1. The drawing processing unit 5 includes a coordinate scaling unit 31, a DDA unit 32, a texture mapping unit 33, a back-image tripling unit 34, and a superimposing/sub-pixel processing unit 35.

The coordinate scaling unit 31 converts a series of display position coordinates (x,y) contained in the apex information into a series of internal processing coordinates (x′,y′). The internal processing coordinates (x′,y′) are in a X′-Y′ coordinate system composed of an X′ axis extending in the first direction and a Y′ axis extending in the second direction. Each sub-pixel constituting the display screen is assigned a pair of internal processing coordinates (x′,y′). More specifically, the coordinate conversion is performed using the following equations.

x′=3x, y′=y

All pixels of the display screen correspond to the coordinates (x,y) in the X-Y coordinate system on a one-to-one basis, and all sub-pixels of the display screen correspond to the coordinates (x′,y′) in the X′-Y′ coordinate system on a one-to-one basis. Accordingly, each pair of coordinates (x,y) corresponds to three pairs of coordinates (x′,y′). For example, (x,y)=(0,0) corresponds to (x′,y′)=(0,0), (1,0), (2,0).

The DDA unit 32, each time it receives from the CPU 4 three pieces of apex information corresponding to three apexes of a polygon, determines sub-pixels to be included in the polygon of the front image using the internal processing coordinates (x′,y′) output from the coordinate scaling unit 31 to indicate an apex of the polygon, using the digital differential analysis (DDA). Also, the DDA unit 32 correlates the texture image pixel coordinates (u,v) with the internal processing coordinates (x′,y′) for each sub-pixel in the polygon it has determined using DDA.

The texture mapping unit 33 reads, from the front texture table 21 stored in the texture memory 3, pieces of pixel information for the texture image in correspondence with sub-pixels in polygons constituting the front image as correlated by the DDA unit 32, and outputs a color value and an α value for each sub-pixel in polygons to the superimposing/sub-pixel processing unit 35. The texture mapping unit 33 also outputs internal processing coordinates (x′,y′) of the sub-pixels, for each of which a color value and an α value are output to the superimposing/sub-pixel processing unit 35, to the back-image tripling unit 34.

The back-image tripling unit 34 reads, from the display image information stored in the frame memory 2, color values of the three primary colors R, G and B for each pixel, receives internal processing coordinates from the texture mapping unit 33, and outputs color values of the pixel corresponding to the sub-pixels of the received internal processing coordinates to the superimposing/sub-pixel processing unit 35, as the color values of the back image at the received internal processing coordinates. More specifically, the back-image tripling unit 34 calculates and assigns three color values for R, G and B to each sub-pixel constituting the back image, using the following equations.

Rb(x′,y′)=Rb(x′+1,y′)=Rb(x′+2,y′)=Ro(x,y),

Gb(x′,y′)=Gb(x′+1,y′)=Gb(x′+2,y′)=Go(x,y),

Bb(x′,y′)=Bb(x′+1,y′)=Bb(x′+2,y′)=Bo(x,y), where

Ro(x,y), Go(x,y), and Bo(x,y) represent, respectively, color values of R, G, and B of a pixel identified by display position coordinates (x,y); Rb(x′,y′), Gb(x′,y′), and Bb(x′,y′) respectively represent color values of R, G, B of a sub-pixel identified by coordinates (x′,y′), Rb(x′+1,y′), Gb(x′+1,y′), and Bb(x′+1,y′) respectively represent color values of R, G, B of a sub-pixel identified by coordinates (x′+1,y′), and Rb(x′+2,y′), Gb(x′+2,y′), and Bb(x′+2,y′) respectively represent color values of R, G, B of a sub-pixel identified by coordinates (x′+2,y′). The sub-pixels identified by internal processing coordinates (x′,y′), (x′+1,y′), and (x′+2,y′) correspond to the pixel identified by display position coordinates (x,y), where the relation between the internal processing coordinates (x′,y′) and the display position coordinates (x,y) is represented by the following equations.

x=[x′/3], y=y′, where

[z] represents an integer that is the largest among the integers no smaller than z.

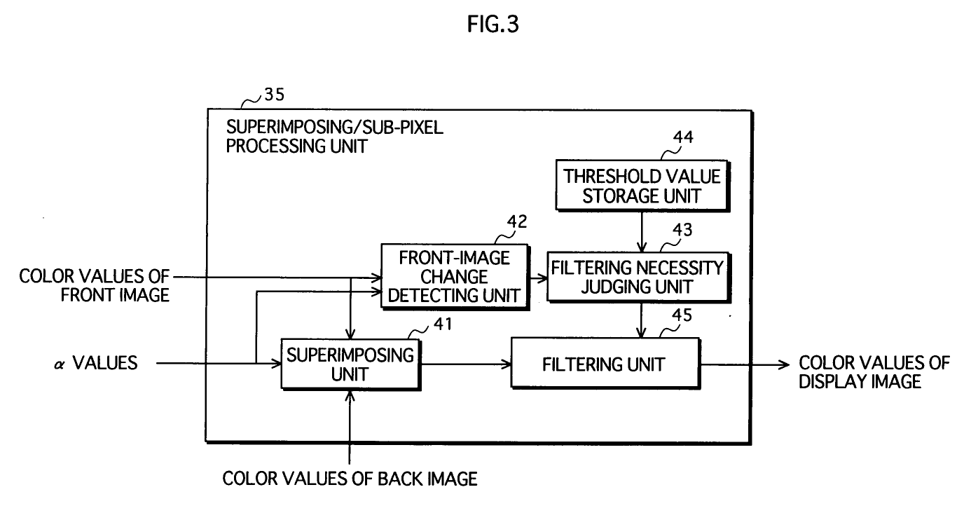

FIG. 3 shows the construction of the superimposing/sub-pixel processing unit 35. The superimposing/sub-pixel processing unit 35 generates the color values of a composite image to be displayed on the display device 1, from the color values and the α values of the front image and the color values of the back image. The superimposing/sub-pixel processing unit 35 includes a superimposing unit 41, a front-image change detecting unit 42, a filtering necessity judging unit 43, a threshold value storage unit 44, and a filtering unit 45.

The superimposing unit 41 calculates color values of a composite image from (a) the color values and α values of the front image output from the texture mapping unit 33 and (b) the color values of the back image output from the back-image tripling unit 34, and outputs the calculated color values of the composite image to the filtering unit 45. More specifically, the color values of the composite image are calculated using the following equations.

Ra(x′,y′)=Rp(x′,y′)×α(x′,y′)+Rb(x′,y′)×(1−α(x′,y′)),

Ga(x′,y′)=Gp(x′,y′)×α(x′,y′)+Gb(x′,y′)×(1−α(x′,y′)),

Ba(x′,y′)=Bp(x′,y′)×α(x′,y′)+Bb(x′,y′)×(1−α(x′,y′)), where

Rp(x′,y′), Gp(x′,y′), and Bp(x′,y′) represent color values of R, G, and B of the front image at internal processing coordinates (x′,y′), α(x′,y′) represents an α value of the front image at internal processing coordinates (x′,y′), Rb(x′,y′), Gb(x′,y′), and Bb (x′,y′) represent color values of R, G, and B of the back image at internal processing coordinates (x′,y′), and Ra(x′,y′), Ga(x′,y′), and Ba(x′,y′) represent color values of R, G, and B of the composite image at internal processing coordinates (x′,y′).

In Embodiment 1, both the color values and α values of the front image are accurate to sub-pixels. However, to achieve the superimposing at each sub-pixel, both types of values are not necessarily accurate to sub-pixels, but only one of the color values or the α values may be accurate to sub-pixels and the other may be accurate to pixels. In such a case, the values with the accuracy of pixel may be expanded to have the accuracy of sub-pixel, as is the case shown in Embodiment 1 where the color values of the front image are expanded to the color values of the back image.

The α values may be used in different ways in image superimposing from the way shown in Embodiment 1, but any method will do for achieving the present invention in so far as the amounts of back image components in composite images increase or decrease monotonously in correspondence with α values.

In Embodiment 1, the α value ranging from “0” to “1” is used. However, a parameter indicating a ratio of a front image to a back image in a composite image may be used instead. For example, a one-bit flag that indicates whether the front image is transparent (“0”) or non-transparent (“1”) maybe used. This binary information can therefore be used to judge whether the filtering process is required or not. In this case, the flag=0 corresponds to α=0, and the flag=1 corresponds to α=1.

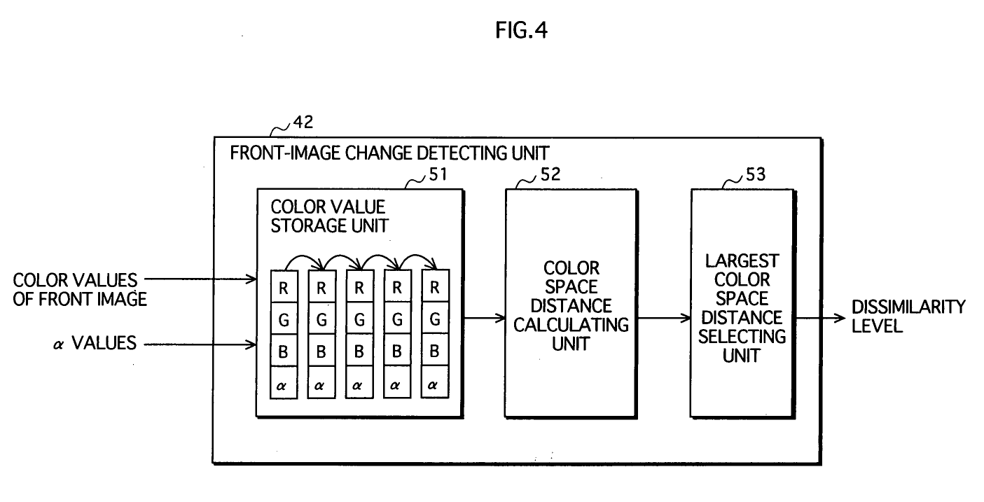

FIG. 4 shows the construction of the front-image change detecting unit 42. The front-image change detecting unit 42 calculates a dissimilarity level of a sub-pixel to the surrounding sub-pixels for each sub-pixel constituting a front image, using what is called Euclidean square distance in a color space including α values. The front-image change detecting unit 42 includes a color value storage unit 51, a color space distance calculating unit 52, and a largest color space distance selecting unit 53.

The following equation defines a Euclidean square distance L between a point (R₁, G₁, B₁, α₁) and a point (R₂, G₂, B₂, α₂) in a color space including α values.

L=(R₂−R₁)²+(G₂−G₁)²+(B₂−B₁)²+(α₂−α₁)²

The color value storage unit 51 receives the color values and α values of the front image from the texture mapping unit 33 in sequence and stores color values and α values of five sub-pixels identified by internal processing coordinates (x′−2,y′), (x′−1,y′), (x′,y′), (x′+1,y′), (x′+2,y′) which align in the first direction, where the processing target is the sub-pixel at internal processing coordinates (x′,y′).

The color space distance calculating unit 52 calculates the Euclidean square distance in a color space including α values for each combination of the five sub-pixels identified by internal processing coordinates (x′−2,y′), (x′−1,y′), (x′,y′), (x′+1,y′), (x′+2,y′), and outputs the calculated Euclidean square distance values to the largest color space distance selecting unit 53. More specifically, the color space distance calculating unit 52 calculates the Euclidean square distance for each combination of the five sub-pixels adjacent to aligned in the above-shown order with a sub-pixel at coordinates (x′,y′) at the center, using the following equations.

L₁ᵢ=(Rpᵢ₋₂−Rpᵢ₋₁)²+(Gpᵢ₋₂−Gpᵢ₋₁)²+(Bpᵢ₋₂−Bpᵢ₋₁)²+(αᵢ₋₂−αᵢ₋₁)²

L₂ᵢ=(Rpᵢ₋₂−Rpᵢ)²+(Gpᵢ₋₂−Gpᵢ)²+(Bpᵢ₋₂−Bpᵢ)²+(αᵢ₋₂−αᵢ)²

L₃ᵢ=(Rpᵢ₋₂−Rpᵢ₊₁)²+(Gpᵢ₋₂−Gpᵢ₊₁)²+(Bpᵢ₋₂−Bpᵢ₊₁)²+(αᵢ₋₂−αᵢ₊₁)²

L₄ᵢ=(Rpᵢ₋₂−Rpᵢ₊₂)²+(Gpᵢ₋₂−Gpᵢ₊₂)²+(Bpᵢ₋₂−Bpᵢ₊₂)²+(αᵢ₋₂−αᵢ₊₂)²

L₅ᵢ=(Rpᵢ₋₁−Rpᵢ)²+(Gpᵢ₋₁−Gpᵢ)²+(Bpᵢ₋₁−Bpᵢ)²+(αᵢ₋₁−αᵢ)²

L₆ᵢ=(Rpᵢ₋₁−Rpᵢ₊₁)²+(Gpᵢ₋₁−Gpᵢ₊₁)²+(Bpᵢ₋₁−Bpᵢ₊₁)²+(αᵢ₋₁−αᵢ₊₁)²

L₇ᵢ=(Rpᵢ₋₁−Rpᵢ₊₂)²+(Gpᵢ₋₁−Gpᵢ₊₂)²+(Bpᵢ₋₁−Bpᵢ₊₂)²+(αᵢ₋₁−αᵢ₊₂)²

L₈ᵢ=(Rpᵢ−Rpᵢ₊₁)²+(Gpᵢ−Gpᵢ₊₁)²+(Bpᵢ−Bpᵢ₊₁)²+(αᵢ−αᵢ₊₁)²

L₉ᵢ=(Rpᵢ−Rpᵢ₊₂)²+(Gpᵢ−Gpᵢ₊₂)²+(Bpᵢ−Bpᵢ₊₂)²+(αᵢ−αᵢ₊₂)²

L₁₀ᵢ=(Rpᵢ₊₁−Rpᵢ₊₂)²+(Gpᵢ₊₁−Gpᵢ₊₂)²+(Bpᵢ₊₁−Bpᵢ₊₂)²+(αᵢ₊₁−αᵢ₊₂)²

where L₁ᵢ to L₁₀ᵢ represent Euclidean square distances, Rpᵢ₋₂ to Rpᵢ₊₂, Gpᵢ₋₂ to Gpᵢ₊₂, and Bpᵢ₋₂ to Bpᵢ₊₂ respectively represent color values of R, G, and B at the corresponding internal processing coordinates (x′−2,y′), (x′−1,y′), (x′,y′), (x′+1,y′), (x′+2,y′), and αᵢ₋₂ to αᵢ₊₂ represent α values at the corresponding internal processing coordinates (x′−2,y′), (x′−1,y′), (x′,y′), (x′+1,y′), (x′+2,y′).

The largest color space distance selecting unit 53 selects the largest value among the Euclidean square distance values L₁ᵢ to L₁₀ᵢ output from the color space distance calculating unit 52, and outputs the selected value Lᵢ to the filtering necessity judging unit 43 as a dissimilarity level of the sub-pixel identified by the internal processing coordinates (x′,y′) to the surrounding sub-pixels.

It should be noted here that the dissimilarity level of each target sub-pixel to the surrounding sub-pixels may be obtained using the Euclidean square distance weighted by α values. For example, the following equation may be used for the calculation.

L₁ᵢ=(Rᵢ₋₂×αᵢ₋₂−Rᵢ₋₁×αᵢ₋₁)²+(Gᵢ₋₂×αᵢ₋₂−Gᵢ₋₁×αᵢ₋₁)²+(Bᵢ₋₂×αᵢ₋₂−Bᵢ₋₁×αᵢ₋₁)²

Also, instead of the Euclidean square distance, the Euclidean distance, the Manhattan distance, or the Chebychev distance may be used to evaluate the dissimilarity level of a sub-pixel, as a numerical value that can be calculated using color values and/or α values.

In Embodiment 1, the front-image change detecting unit 42 selects the largest dissimilarity level value as a value indicating a difference in the color value of a sub-pixel from the surrounding sub-pixels. However, the smallest similarity level value may be selected instead, for the same purpose.

In Embodiment 1, the dissimilarity level of each target sub-pixel is calculated in comparison with four surrounding sub-pixels that are the two sub-pixels before and the two sub-pixels after the target sub-pixel in the first direction. However, the dissimilarity level of each target sub-pixel is calculated in comparison with one or more surrounding sub-pixels. However, it is preferable that the sub-pixels in the internal processing coordinate system that are used as comparison objects in calculation of dissimilarity level of a sub-pixel are also used as the members with which, in the case the sub-pixel has a prominent luminance value compared with the surrounding sub-pixels, the sub-pixel is smoothed out (the filtering is performed). This is because it makes the judgment, which will be described later, on whether to perform the filtering (smooth-out) on the sub-pixel more accurate.

The filtering necessity judging unit 43 shown in FIG. 3 reads a threshold value from the threshold value storage unit 44, and compares the threshold value with the dissimilarity level Lᵢ output from the largest color space distance selecting unit 53. The filtering necessity judging unit 43 outputs “1” or “0” to a luminance selection unit 64 as a judgment result value, where the judgment result value “1” indicates that the dissimilarity level Lᵢ is larger than the threshold value, and the judgment result value “0” indicates that the dissimilarity level Lᵢ is no larger than the threshold value.

The threshold value storage unit 44 stores the threshold value used by the filtering necessity judging unit 43.

In Embodiment 1, a dissimilarity level of each sub-pixel of the front image to the surrounding sub-pixels is calculated using the Euclidean square distance in a color space including α values. However, the dissimilarity level may be calculated using only the primary colors R, G and B excluding α values. It should be noted however that the exclusion of α values makes the judgment on whether to perform the filtering (smooth-out) on the sub-pixel less accurate. More specifically, it may be judged that the filtering is not required, while it is required in actuality, when a target sub-pixel is hardly different from the surrounding sub-pixels in color values of R, G and B of the front image, but is greatly different in the α values, resulting in the observance of a color drift.

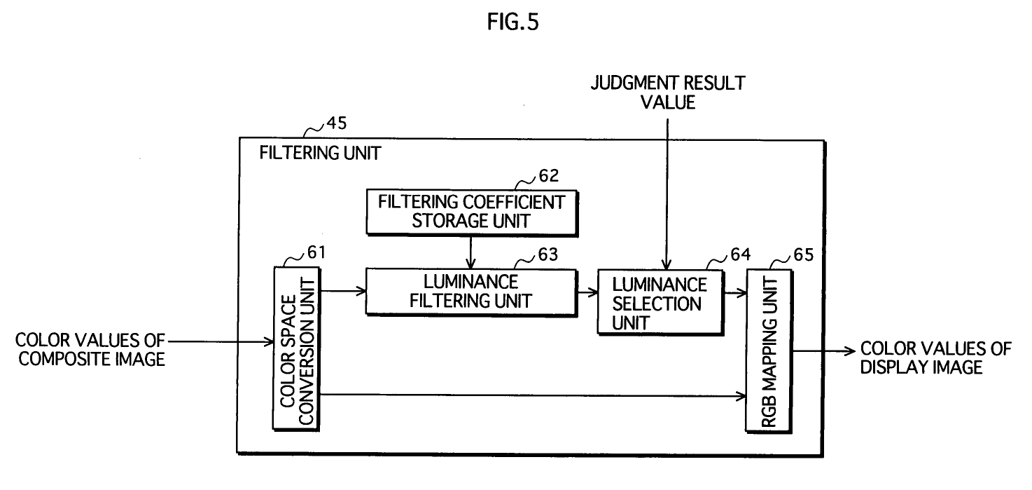

FIG. 5 shows the construction of the filtering unit 45. The filtering unit 45 performs a filtering only on sub-pixels that require the filtering, among sub-pixels constituting the composite image, and generates the color values of an image to be displayed. The filtering unit 45 includes a color space conversion unit 61, a filtering coefficient storage unit 62, a luminance filtering unit 63, a luminance selection unit 64, and an RGB mapping unit 65.

The color space conversion unit 61 converts the color values of the R-G-B color space received from the superimposing unit 41 into values of the luminance, blue-color-difference, and red-color-difference of a Y-Cb-Cr color space, outputs the luminance values to the luminance filtering unit 63, and outputs the blue-color-difference value and the red-color-difference values to the RGB mapping unit 65. More specifically, the conversion is performed using the following equations.

Y(x′,y′)=0.2999×Ra(x′,y′)+0.587×Ga(x′,y′)+0.114×Ba(x′,y′),

Cb(x′,y′)=−0.1687×Ra(x′,y′)−0.3313×Ga(x′,y′)+0.5×Ba(x′,y′),

Cr(x′,y′)=0.5×Ra(x′,y′)−0.4187×Ga(x′,y′)−0.0813×Ba(x′,y′), where

Y(x′,y′), Cb(x′,y′), and Cr(x′,y′) represent the luminance, blue-color-difference, and red-color-difference at internal processing coordinates (x′,y′), respectively.

The filtering coefficient storage unit 62 stores filtering coefficients C₁, C₂, C₃, C₄, and C₅. More specifically, the filtering coefficients C₁, C₂, C₃, C₄, and C₅ are values 1/9, 2/9, 3/9, 2/9, and 1/9, respectively.

The luminance filtering unit 63 includes a buffer for holding luminance values of five sub-pixels identified by internal processing coordinates (x′−2,y′), (x′−1,y′), (x′,y′), (x′+1,y′), (x′+2,y′) which align in the first direction, where the processing target is the sub-pixel at internal processing coordinates (x′,y′), and stores the luminance values of the composite image into the buffer in sequence as received from the color space conversion unit 61. The luminance filtering unit 63 also acquires filtering coefficients from the filtering coefficient storage unit 62, performs a filtering process for smoothing out the five luminance values stored in the buffer using the acquired filtering coefficients, and calculates the luminance value of the target sub-pixel at internal processing coordinates (x′,y′). The luminance filtering unit 63 then outputs both luminance values of the target sub-pixel obtained before and after the filtering process (pre- and post-filtering luminance values) to the luminance selection unit 64. More specifically, the luminance filtering unit 63 performs the filtering process using the following equation.

Y₀ᵢ=C₁×Yᵢ₋₂+C₂×Yᵢ₋₁+C₃×Yᵢ+C₄ ×Yᵢ₊₁+C₅×Y_{i+2,}

where Y₀ᵢ represents the luminance of the target sub-pixel at internal processing coordinates (x′,y′) after it has been subject to the filtering process, Yᵢ₋₂ to Yᵢ₊₂ respectively represent luminance values at the corresponding internal processing coordinates (x′−2,y′), (x′−1,y′), (x′,y′), (x′+1,y′), (x′+2,y′), and C₁ to C₅ represent filtering coefficients.

The luminance selection unit 64 selects, based on a judgment result value received from the filtering necessity judging unit 43, either of the luminance values of before and after the filtering process received from the luminance filtering unit 63, and outputs the selected luminance value to the RGB mapping unit 65. More specifically, the luminance selection unit 64 selects and outputs the luminance value of after the filtering process (post-filtering luminance value) if it receives the judgment result value “1” from the filtering necessity judging unit 43; and selects and outputs the luminance value of before the filtering process (pre-filtering luminance value) if it receives the judgment result value “0” from the filtering necessity judging unit 43.

The RGB mapping unit 65 includes buffers respectively for holding (a) luminance values of three sub-pixels consecutively aligned on the X′ axis (in the first direction) of the X′-Y′ coordinate system composed of internal processing coordinates and (b) blue-color-difference values and (c) red-color-difference values of five sub-pixels consecutively aligned on the X′ axis of the X′-Y′ coordinate system. The RGB mapping unit 65 stores, sequentially into the buffers starting with the end of the buffers, luminance values received from the luminance selection unit 64 and blue-color-difference values and red-color-difference values received from the color space conversion unit 61. Each time it stores three luminance values, the RGB mapping unit 65 extracts blue-color-difference values and red-color-difference values of three consecutive sub-pixels on the X′ axis from the start of the buffers, and calculates a blue-color-difference value and a red-color-difference value of a pixel in the display position coordinate system corresponding to the three sub-pixels. More specifically, the RGB mapping unit 65 calculates the blue-color-difference value and the red-color-difference value of the pixel in the display position coordinate system, each as an average of the three sub-pixel values, using the following equations.

Cb_{—}ave(x,y)=(Cb(x′,y′)+Cb(x′+1,y′)+Cb(x′+2,y′))/3,

Cr_{—}ave(x,y)=(Cr(x′,y′)+Cr(x′+1,y′)+Cr(x′+2,y′))/3, where

Cb_ave(x,y) and Cr_ave(x,y) represent the blue-color-difference value and the red-color-difference value of the pixel in the display position coordinate system, Cb(x′,y′) and Cr(x′,y′) represent the blue-color-difference value and the red-color-difference value of sub-pixels at internal processing coordinates (x′,y′), Cb(x′+1,y′) and Cr (x′+1,y′) represent the blue-color-difference value and the red-color-difference value of sub-pixels at internal processing coordinates (x′+1,y′), and Cb(x′+2,y′) and Cr(x′+2,y′) represent the blue-color-difference value and the red-color-difference value of sub-pixels at internal processing coordinates (x′+2,y′).

The RGB mapping unit 65 then calculates the color values of the pixel in the display position coordinate system using the obtained blue-color-difference value and the red-color-difference value of the pixel and using the luminance values of the three consecutive sub-pixels stored in the buffer, thus converting the Y-Cb-Cr color space into the R-G-B color space. More specifically, the RGB mapping unit 65 calculates the color values of the pixel, using the following equations.

R(x,y)=Y(x′,y′)+1.402×Cr_{—}ave(x,y),

G(x,y)=Y(x′+1,y′)−0.34414×Cb_{—}ave(x,y)−0.71414×Cr_{—}ave(x,y),

B(x,y)=Y(x′+2,y′)+1.772×Cb_{—}ave(x,y), where

R(x,y), G(x,y), and B(x,y) represent the color values of the pixel in the display position coordinate system.

The color values obtained here are written over the color values of the same pixel stored in the frame memory 2 that were read by the back-image tripling unit 34.

With the above-described construction, the display apparatus of the present invention performs the filtering process only on such sub-pixels of the composite image as correspond to sub-pixels of the front image having color values greatly different from adjacent sub-pixels and being expected to cause color drifts to be observed by the viewers. This reduces the area of the composite image that overlaps the back image (that has been subject to the filtering process once) and is subject to the filtering process, thus preventing the back image from being deteriorated.

In Embodiment 1, the color value and α value are used to detect a change in color in the front image. However, not limited to these elements, other elements may be used to detect a change in color. The following is a description of an example in which the luminance value and α value are used to detect a change in color in the front image.

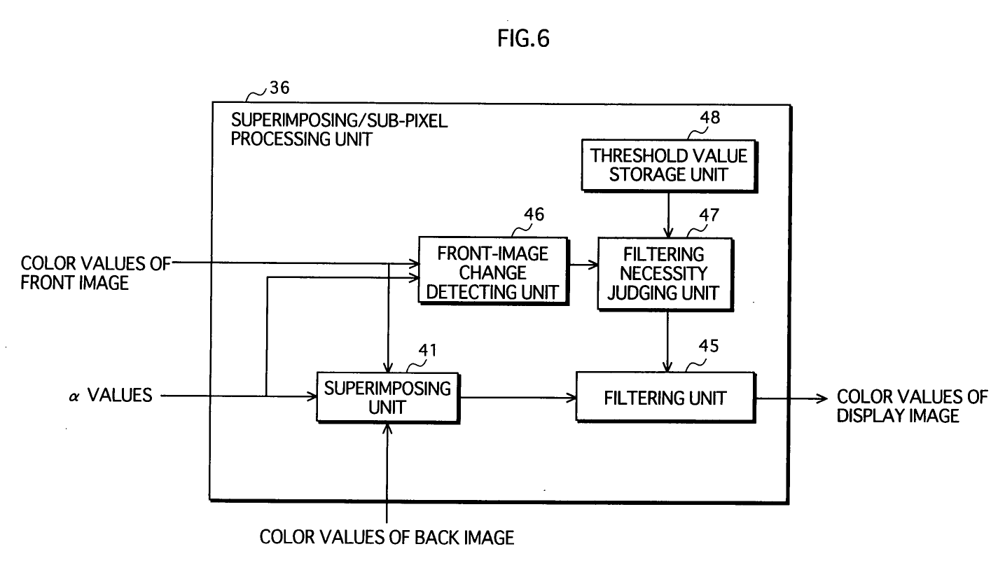

FIG. 6 shows the construction of a superimposing/sub-pixel processing unit 36 for detecting a change in color in the front image using the luminance value and α value. The superimposing/sub-pixel processing unit 36 differs from the superimposing/sub-pixel processing unit 35 in that a front-image change detecting unit 46, a filtering necessity judging unit 47, and a threshold value storage unit 48 have respectively replaced the corresponding units 42, 43, and 44. Explanation on the other components of the superimposing/sub-pixel processing units 36 is omitted here since they operate the same as the corresponding components in the superimposing/sub-pixel processing units 35 that have the same reference numbers.

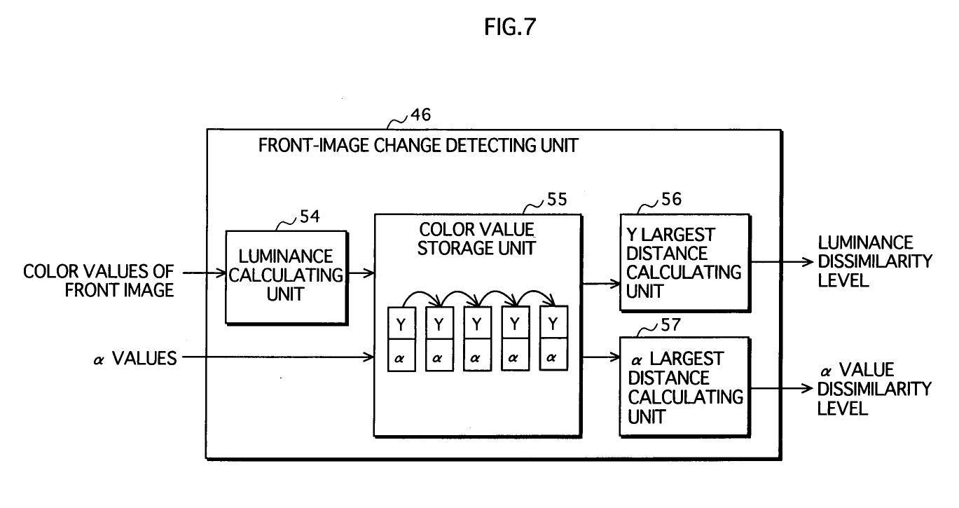

FIG. 7 shows the construction of the front-image change detecting unit 46. The front-image change detecting unit 46 calculates a dissimilarity level of a sub-pixel to the surrounding sub-pixels for each sub-pixel constituting a front image, using the luminance values and α values. The front-image change detecting unit 46 includes a luminance calculating unit 54, a color value storage unit 55, a Y largest distance calculating unit 56, and an α largest distance calculating unit 57.

The luminance calculating unit 54 calculates a luminance value from a color value of the front image read from the texture mapping unit 33, and outputs the calculated luminance value to the color value storage unit 55. It should be noted here that the luminance calculating unit 54 calculates the luminance value in the same manner as the color space conversion unit 61 converts the R-G-B color space to the Y-Cb-Cr color space.

The color value storage unit 55 sequentially reads the a values and luminance values of the front image respectively from the texture mapping unit 33 and the luminance calculating unit 54, and stores luminance values and α values of five sub-pixels identified by internal processing coordinates (x′−2,y′), (x′−1,y′), (x′,y′), (x′+1,y′), (x′+2,y′) which align in the first direction, where the processing target is the sub-pixel at internal processing coordinates (x′,y′).

The Y largest distance calculating unit 56 calculates a difference between the largest value and the smallest value among the luminance values of the sub-pixels at internal processing coordinates (x′−2,y′), (x′−1,y′), (x′,y′), (x′+1,y′), (x′+2,y′), and outputs the calculated difference value to the filtering necessity judging unit 47 as a luminance dissimilarity level of the sub-pixel at the internal processing coordinates (x′,y′).

The α largest distance calculating unit 57 calculates a difference between the largest value and the smallest value among the α values of the sub-pixels at internal processing coordinates (x′−2,y′), (x′−1,y′), (x′,y′), (x′+1,y′), (x′+2,y′), and outputs the calculated difference value to the filtering necessity judging unit 47 as an α value dissimilarity level of the sub-pixel at the internal processing coordinates (x′,y′).

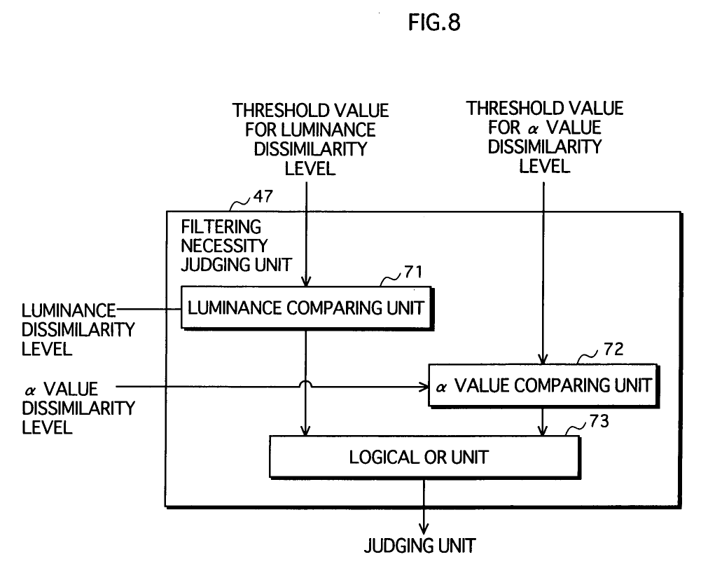

FIG. 8 shows the construction of the filtering necessity judging unit 47. The filtering necessity judging unit 47 compares the luminance dissimilarity level output from the Y largest distance calculating unit 56 with a threshold value, and compares the α value dissimilarity level output from the a largest distance calculating unit 57 with a threshold value. The filtering necessity judging unit 47 includes a luminance comparing unit 71, an α value comparing unit 72, and a logical OR unit 73.

The luminance comparing unit 71 reads a threshold value for the luminance dissimilarity level from the threshold value storage unit 48, and compares the threshold value with the luminance dissimilarity level output from the Y largest distance calculating unit 56. The luminance comparing unit 71 outputs “1” or “0” to the logical OR unit 73 as a judgment result value, where the judgment result value “1” indicates that the luminance dissimilarity level is larger than the threshold value, and the judgment result value “0” indicates that the luminance dissimilarity level is no larger than the threshold value.

The α value comparing unit 72 reads a threshold value for the α value dissimilarity level from the threshold-value storage unit 48, and compares the threshold value with the α value dissimilarity level output from the α largest distance calculating unit 57. The α value comparing unit 72 outputs “1” or “0” to the logical OR unit 73 as a judgment result value, where the judgment result value “1” indicates that the α value dissimilarity level is larger than the threshold value, and the judgment result value “0” indicates that the α value dissimilarity level is no larger than the threshold value.

The logical or unit 73 outputs a value “1” to the luminance selection unit 64 if at least one of the judgment result values received from the luminance comparing unit 71 and the α value comparing unit 72 is “1”, and outputs a value “0” to the luminance selection unit 64 if both the received judgment result values are “0”.

The threshold value storage unit 48 shown in FIG. 6 stores the threshold value for the luminance dissimilarity level and the threshold value for the α value dissimilarity level. More specifically, the threshold value storage unit 48 stores a value “1/16” as the threshold value for both values when, as is the case with Embodiment 1, each of the luminance value and the α value takes on values from “0” to “1” inclusive, that is, when both values are variables standardized by “1”, where the value “1/16” has been determined based on the perceptibility to the human eye of the change in color.

It should be noted here however that the threshold values for the luminance dissimilarity level and α value dissimilarity level are not limited to “1/16”, but may be any value between “0” and “1” inclusive.

Also, the threshold values for the luminance dissimilarity level and the α value dissimilarity level may be different from each other.

It should be noted here that the luminance dissimilarity level and the α value dissimilarity level may not necessarily be compared with the threshold values separately. For example, the largest value Lᵢ among values L₁ᵢ to L₁₀ᵢ obtained using the following equations may be used as a dissimilarity level that has taken both the luminance values and α values into account.

$${L}_{1 i} = \vert {Y}_{i - 2} - {Y}_{i - 1} \vert + \vert {α}_{i - 2} - {α}_{i - 1} \vert , \\ {L}_{2 i} = \vert {Y}_{i - 2} - {Y}_{i} \vert + \vert {α}_{i - 2} - {α}_{i} \vert , \\ {L}_{3 i} = \vert {Y}_{i - 2} - {Y}_{i + 1} \vert + \vert {α}_{i - 2} - {α}_{i + 1} \vert , \\ {L}_{4 i} = \vert {Y}_{i - 2} - {Y}_{i + 2} \vert + \vert {α}_{i - 2} - {α}_{i + 2} \vert , \\ {L}_{5 i} = \vert {Y}_{i - 1} - {Y}_{i} \vert + \vert {α}_{i - 1} - {α}_{i} \vert , \\ {L}_{6 i} = \vert {Y}_{i - 1} - {Y}_{i + 1} \vert + \vert {α}_{i - 1} - {α}_{i + 1} \vert , \\ {L}_{7 i} = \vert {Y}_{i - 1} - {Y}_{i + 2} \vert + \vert {α}_{i - 1} - {α}_{i + 2} \vert , \\ {L}_{8 i} = \vert {Y}_{i} - {Y}_{i + 1} \vert + \vert {α}_{i} - {α}_{i + 1} \vert , \\ {L}_{9 i} = \vert {Y}_{i} - {Y}_{i + 2} \vert + \vert {α}_{i} - {α}_{i + 2} \vert , \\ {L}_{10 i} = \vert {Y}_{i + 2} - {Y}_{i + 2} \vert + \vert {α}_{i + 2} - {α}_{i + 2} \vert ,$$

where |X| represents the absolute value of X.

The use of “luminance” dissimilarity level like the above ones in the judgment on the necessity of the filtering process effectively reduces the amount of calculation required for the calculation of dissimilarity level of a sub-pixel to the surrounding sub-pixels to be performed for each sub-pixel.

The luminance used in Embodiment 1 is an element that expresses the brightness of a displayed color image accurately. However, it is also possible to use element “G” among the primary colors R, G and B though it expresses brightness less accurately than the luminance. For example, the luminance, blue-color-difference, and red-color-difference of the Y-Cb-Cr color space may be represented using values of G, as expressed in the following equations.

$$Y ( {x}^{′} , {y}^{′} ) = G ( {x}^{′} , {y}^{′} ) , \\ Cb ( {x}^{′} , {y}^{′} ) = - G ( {x}^{′} , {y}^{′} ) + B ( {x}^{′} , {y}^{′} ) , \\ Cr ( {x}^{′} , {y}^{′} ) = R ( {x}^{′} , {y}^{′} ) - G ( {x}^{′} , {y}^{′} ) .$$

Also, the Y-Cb-Cr color space may be converted to the R-G-B color space using the following equations.

$$R ( {x}^{′} , {y}^{′} ) = Y ( {x}^{′} , {y}^{′} ) + Cr ( {x}^{′} , {y}^{′} ) , \\ G ( {x}^{′} , {y}^{′} ) = Y ( {x}^{′} , {y}^{′} ) , \\ B ( {x}^{′} , {y}^{′} ) = Y ( {x}^{′} , {y}^{′} ) + Cb ( {x}^{′} , {y}^{′} ) .$$

With this arrangement, the amount of calculation required for the conversion to the Y-Cb-Cr color space is reduced effectively.

Operation

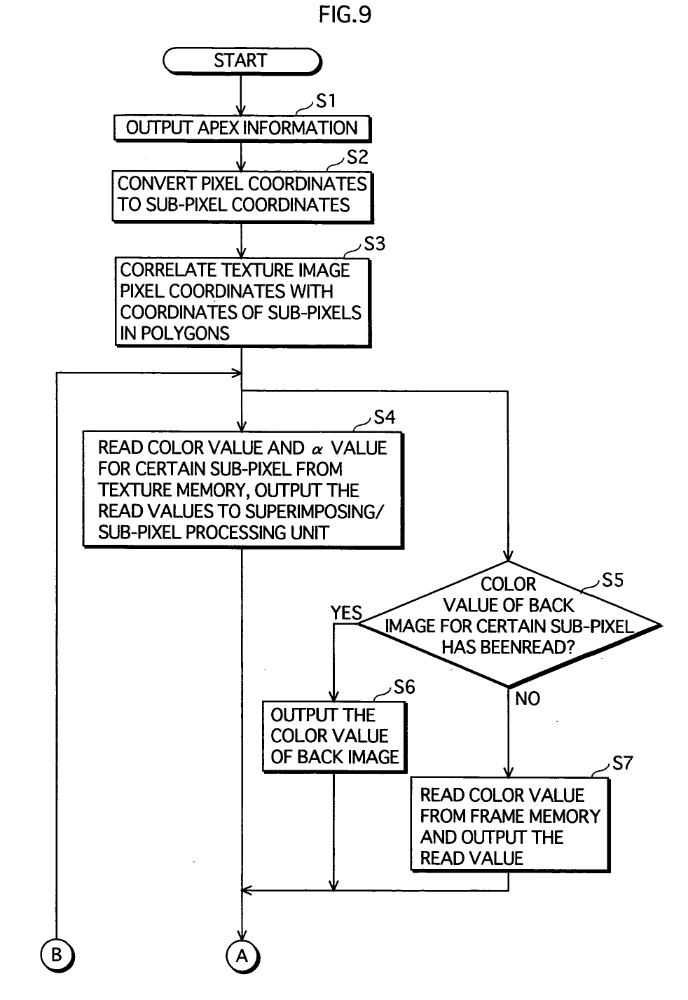

The operation of the display apparatus 100 will be described with reference to FIGS. 9-11.

FIGS. 9-11 are flowcharts showing the operation procedures of the display apparatus 100 in Embodiment 1. The display apparatus 100 updates a display image polygon by polygon, where polygons constitute the front image. Here, the operation procedures of the display apparatus 100 will be described in regard with one of the polygons constituting the front image.

First, the coordinate scaling unit 31 of the drawing processing unit 5 receives the apex information from the CPU 4, where the apex information shows correspondence between (a) pixel coordinates indicating a position in the display screen that corresponds to the apex of a polygon constituting the front image that is superimposed on a currently displayed image, and (b) coordinates of a corresponding pixel in the texture image which is mapped onto the front image (S1). The coordinate scaling unit 31 converts the display position coordinates contained in the apex information into the internal processing coordinates that correspond to sub-pixels of the polygon (S2). The DDA unit 32 correlates the texture image pixel coordinates, which are shown in the front texture table 21 stored in the texture memory 3, with the internal processing coordinates output from the coordinate scaling unit 31, for each sub-pixel in polygons constituting the front image, using the digital differential analysis (DDA) (S3).

The following description of the procedures concerns one of the sub-pixels constituting the polygon.

The texture mapping unit 33 reads a piece of pixel information and an α value of a texture image pixel that corresponds to a certain sub-pixel in the front image, and outputs the read piece of pixel information and α value to the superimposing/sub-pixel processing unit 35 (S4). In the following step, it is judged whether color values of a pixel in an image currently displayed on the display screen that corresponds to the certain sub-pixel in the front image have already been read (S5). If they have already been read (“Yes” in step S5), the back-image tripling unit 34 outputs to the superimposing/sub-pixel processing unit 35 the color values of the currently displayed image pixel as the color values of the back image that corresponds to the certain sub-pixel in the front image (S6). If the color values of the currently displayed image pixel have not been read (“No” in step S5), the back-image tripling unit 34 reads color values of the currently displayed image pixel that corresponds to the certain sub-pixel, from the frame memory, and outputs the read color values to the superimposing/sub-pixel as the color values of the back image (S7).

The superimposing unit 41 calculates a color value of the certain sub-pixel in a composite image from (a) the color values and the α value of the front image output from the texture mapping unit 33 and (b) the color values of the back image output from the back-image tripling unit 34 (S8), and outputs the calculated color values of the composite image sub-pixel to the color space conversion unit 61 of the filtering unit 45. The color space conversion unit 61 converts the color values of the R-G-B color space received from the superimposing unit 41 into the values of the luminance, blue-color-difference, and red-color-difference of the Y-Cb-Cr color space, outputs the luminance values to the luminance filtering unit 63, and outputs the blue-color-difference value and the red-color-difference values to the RGB mapping unit 65 (S9). The luminance filtering unit 63 stores the luminance value received from the color space conversion unit 61 into the buffer (S10) The buffer holds luminance values of five sub-pixels including the certain sub-pixel and four other sub-pixels that are adjacent to the certain sub-pixel in the first direction and have been processed prior to the certain sub-pixel. The luminance filtering unit 63 regards a sub-pixel at the center of the five sub-pixels as the target sub-pixel, and calculates the luminance value of the target sub-pixel by performing a filtering process in accordance with the filtering coefficient received from the filtering coefficient storage unit 62 (S11), and outputs the pre-filtering and post-filtering luminance values of the target sub-pixel to the luminance selection unit 64.

The color value storage unit 51 stores the color values and α value of the certain sub-pixel in the front image received from the texture mapping unit 33 (S12). As a result of this, the color value storage unit 51 currently stores color values and α values of five sub-pixels including the certain sub-pixel and four other sub-pixels that are adjacent to the certain sub-pixel in the first direction and have been processed prior to the certain sub-pixel. The color space distance calculating unit 52 calculates the Euclidean square distance in a color space including α values for each combination of the five sub-pixels identified whose values are stored in the color value storage unit 51. The largest color space distance selecting unit 53 selects the largest value among the Euclidean square distance values output from the color space distance calculating unit 52, and outputs the selected value to the filtering necessity judging unit 43 as a dissimilarity level of the target sub-pixel to the surrounding sub-pixels (S13).

The filtering necessity judging unit 43 judges whether the dissimilarity level output from the largest color space distance selecting unit 53 is larger than the threshold value stored in the threshold value storage unit 44 (S14) If the dissimilarity level is larger than the threshold value (“Yes” in step S14), the filtering necessity judging unit 43 outputs judgment result value “1”, which indicates that the filtering is necessary, to the luminance selection unit 64 (S15) If the dissimilarity level is no larger than the threshold value (“No” in step S14), the filtering necessity judging unit 43 outputs judgment result value “0”, which indicates that the filtering is not necessary, to the luminance selection unit 64 (S16).

The luminance selection unit 64 judges whether the judgment result value output by the filtering necessity judging unit 43 is “1” (S17) If the judgment result value “1” has been output (“Yes” in step S17), the luminance selection unit 64 outputs the post-filtering luminance value to the RGB mapping unit 65 (S18). If the judgment result value “0” has been output (“No” in step S17), the luminance selection unit 64 outputs the pre-filtering luminance value to the RGB mapping unit 65 (S19).

The steps described so far are repeated by shifting the target sub-pixel one at a time in the first direction until the luminance values of sub-pixels that correspond to one pixel in the display screen are stored in the buffers for storing (a) luminance values of three consecutively aligned sub-pixels output from the luminance selection unit 64 and (b) blue-color-difference values and (c) red-color-difference values of five consecutively aligned sub-pixels output from the color space conversion unit 61 (“No” in step S20). Each time the luminance values of sub-pixels that correspond to one pixel in the display screen are stored in the buffers (“Yes” in step S20), the RGB mapping unit 65 converts the Y-Cb-Cr color space into the R-G-B color space using the luminance values, the blue-color-difference values, and the red-color-difference values of the three consecutively aligned sub-pixels, that is, calculates the color values of the pixel in the display screen that corresponds to the three consecutively aligned sub-pixels (S21). The color values obtained here are written over the color values of the same pixel stored in the frame memory 2 (S22).

The steps described so far are repeated by shifting the target sub-pixel one at a time in the first direction until all the sub-pixels constituting the polygon that has been correlated by the DDA unit 32 with the pixel in the texture image are processed (S23).

The above-described operation procedures are repeated as many times as there are polygons constituting the front image. With such an operation, the display apparatus of the present invention performs the filtering process only on such sub-pixels of the composite image as correspond to sub-pixels of the front image having color values greatly different from adjacent sub-pixels and being expected to cause color drifts to be observed by the viewers. This reduces the area of the composite image that overlaps the back image (that has been subject to the filtering process once) and is subject to the filtering process, thus preventing the back image from being deteriorated.

### EXAMPLE

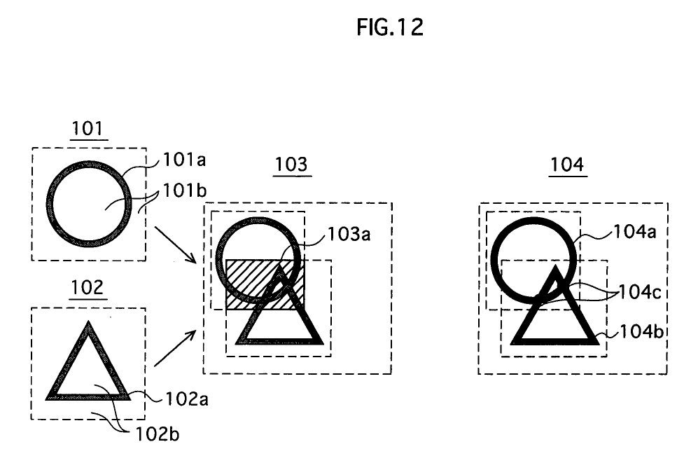

FIG. 12 shows an example of display images displayed on a conventional display apparatus and the display apparatus 100 in Embodiment 1 of the present invention. In FIG. 12, 103 indicates a display image displayed on a conventional display apparatus, and 104 indicates a display image displayed on the display apparatus 100 in Embodiment 1. Both display images 103 and 104 are composite images of a front image 101 and a back image 102, where only the back image 102 has been subject to the filtering process. The front image 101 includes: a non-transparent area 101a shaped like a ring; and transparent areas 10b. The back image 102 includes: a non-transparent area 102a shaped like a triangle; and transparent areas 102b. When the front image 101 is superimposed on the back image 102 to be displayed by the conventional display apparatus as the composite image 103, the whole area of the front image 101 is subject to the filtering process. As a result, the filtering process is performed twice on an area 103a that is an overlapping area of the front image 101 and the back image 102 in the composite image.

In contrast, in the display image 104 displayed by the display apparatus 100 in Embodiment 1, the filtering process is performed twice only on an area 104c at which an area 104a and an area 104b cross each other, the area 104a corresponding to the non-transparent area 101a and the area 104b corresponding to the non-transparent area 102a. This is because the display apparatus 100 in Embodiment 1 subjects only the non-transparent area 101a in the front image 101 to the filtering process.

Embodiment 2

General Outlines

In Embodiment 1, the display apparatus 100 judges on the necessity of the filtering process based on the dissimilarity level of each sub-pixel to the surrounding sub-pixels in the front image so that the area of the composite image that overlaps the back image and is subject to the filtering process is limited to a small area. In Embodiment 2, the display apparatus varies the degree of the smooth-out effect provided by the filtering process according to the dissimilarity level of each sub-pixel to the surrounding sub-pixels in the front image, for a similar purpose of reducing the accumulation of the smooth-out effect to provide a high-quality image display with the accuracy of sub-pixel.

Construction

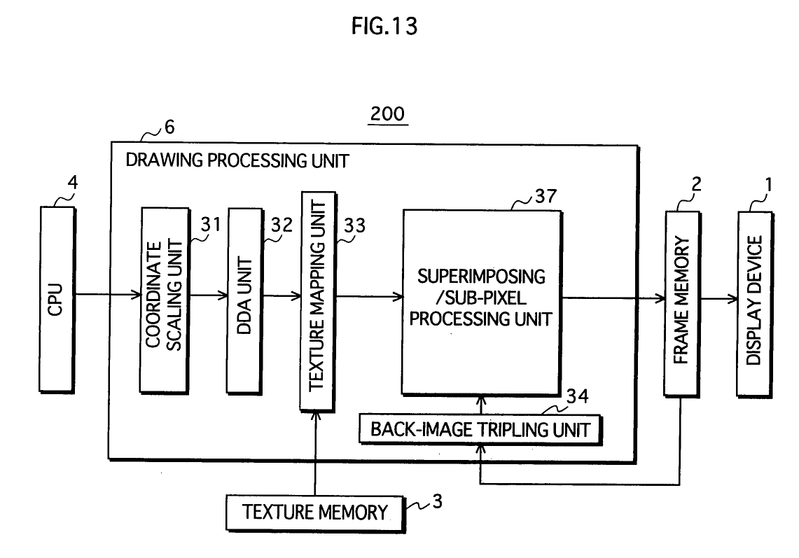

FIG. 13 shows the construction of the display apparatus 200 in Embodiment 2 of the present invention. As shown in FIG. 13, the display apparatus 200 has the same construction as the display apparatus 100 except for a superimposing/sub-pixel processing unit 37 replacing the superimposing/sub-pixel processing unit 35. Explanation on the other components of the display apparatus 200 is omitted here since they operate the same as the corresponding components in the display apparatus 100 that have the same reference numbers.

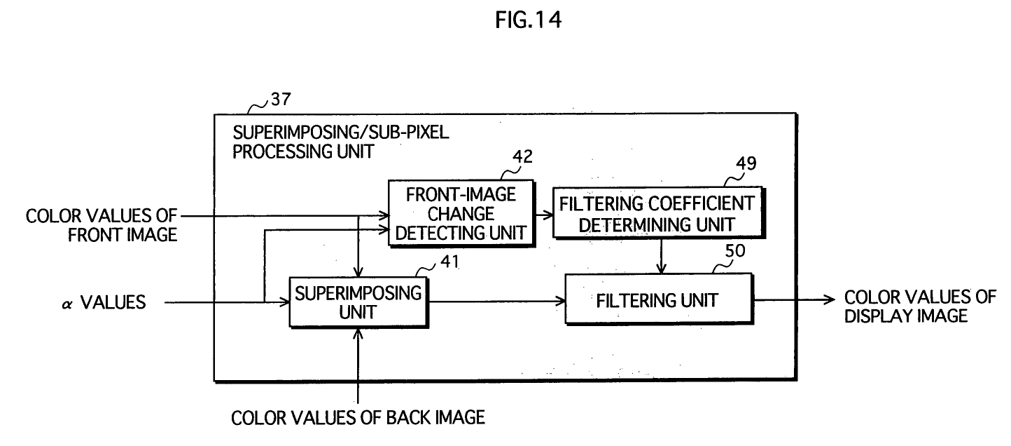

FIG. 14 shows the construction of the superimposing/sub-pixel processing unit 37. The superimposing/sub-pixel processing unit 37 differs from the superimposing/sub-pixel processing unit 35 in Embodiment 1 in that a filtering coefficient determining unit 49 and a filtering unit 50 have replaced the filtering necessity judging unit 43 and the filtering unit 45. The following is an explanation of the filtering coefficient determining unit 49 and the filtering unit 50 having different functions from the replaced units in Embodiment 1.

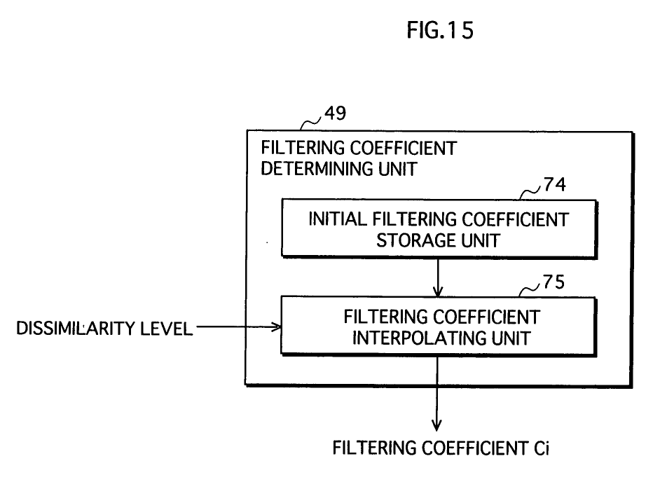

FIG. 15 shows the construction of the filtering coefficient determining unit 49. The filtering coefficient determining unit 49 determines a filtering coefficient in accordance with a dissimilarity level received from the front-image change detecting unit 42. The filtering coefficient determining unit 49 includes an initial filtering coefficient storage unit 74 and a filtering coefficient interpolating unit 75.

The initial filtering coefficient storage unit 74 stores filtering coefficients that are set in correspondence with a maximum dissimilarity level of a sub-pixel in the front image. More specifically, the initial filtering coefficient storage unit 74 stores values 1/9, 2/9, 3/9, 2/9, and 1/9 as filtering coefficients C₁, C₂, C₃, C₄, and C₅.

The filtering coefficient interpolating unit 75 determines a filtering coefficient for internal processing coordinates (x′,y′) in accordance with the dissimilarity level Lᵢ received from the front-image change detecting unit 42, and outputs the determined filtering coefficient to a luminance filtering unit 66 of the filtering unit 50.

It should be noted here that as is the case with Embodiment 1, it is preferable that the sub-pixels in the internal processing coordinate system that are used as comparison objects by the front-image change detecting unit 42 in calculation of dissimilarity level of a sub-pixel are also used as the members with which the sub-pixel is smoothed out (the filtering is performed). This is because it makes the determination of filtering coefficients to be assigned to the sub-pixel more accurate.

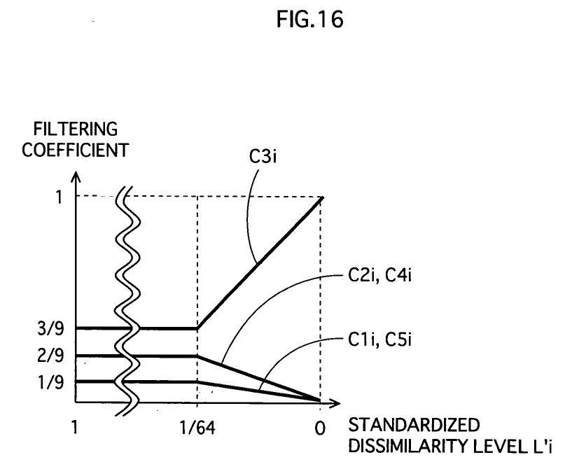

FIG. 16 shows relationships between the dissimilarity level and the filtering coefficient. In FIG. 16, the horizontal axis represents the dissimilarity level L′ᵢ that is obtained by standardizing the dissimilarity level Lᵢ by “1”. More specifically, the dissimilarity level L′ᵢ is obtained by dividing the dissimilarity level Lᵢ by Lmax which is the maximum value of the dissimilarity level Lᵢ. The vertical axis in FIG. 16 represents filtering coefficients C₁ᵢ, C₂ᵢ, C₃ᵢ, C₄ᵢ, and C₅ᵢ. Here, the less the difference between each filtering coefficient is, the more the effect of the smoothing out. The filtering coefficients C₁ᵢ, C₂ᵢ, C₃ᵢ, C₄ᵢ, and C₅ᵢ are set so that their sum is always “1”, and thus the amount of energy of light for each of R, G, and B of the whole image does not change before or after the filtering (smooth-out).

As shown in FIG. 16, when the dissimilarity level L′ᵢ is greater than “64/1” and no greater than “1”, the filtering coefficients C₁ᵢ, C₂ᵢ, C₃ᵢ, C₄ᵢ, and C₅ᵢ take on the values stored in the initial filtering coefficient storage unit 74, respectively; and when the dissimilarity level L′ᵢ is no smaller than “0” and no greater than “64/1”, the filtering coefficients C₁ᵢ, C₂ᵢ, C₃ᵢ, C₄ᵢ, and C₅ᵢ take on linear-interpolated values from the values stored in the initial filtering coefficient storage unit 74 to the values that do not produce any effect of smoothing-out (that is, values “0”, “0”, “1”, “0”, and “0” as filtering coefficients C₁, C₂, C₃, C₄, and C₅)

More specifically, the filtering coefficients C₁ᵢ, C₂ᵢ, C₃ᵢ, C₄ᵢ, and C₅ᵢ at internal processing coordinates (x′,y′) are obtained using the following equations.

A) For L′ᵢ≧1/64:

C₁ᵢ=1/9,

C₂ᵢ=2/9,

C₃ᵢ=3/9,

C₄ᵢ=2/9,

C₅ᵢ=1/9.

B) For L′ᵢ<1/64:

C₁ᵢ=L′ᵢ×64/9,

C₂ᵢ=L′ᵢ×128/9,

C₃ᵢ=1−L′ᵢ×384/9,

C₄ᵢ=L′ᵢ×128/9,

C₅ᵢ=L′ᵢ×64/9.

It should be noted here that any relationships between the dissimilarity level and the filtering coefficient may be used, not limited to those shown in FIG. 16. For example, the sum of the filtering coefficients C₁ᵢ, C₂ᵢ, C₃ᵢ, C₄ᵢ, and C₅ᵢ may be set to a value other than “1” so that the display image has a certain visual effect.

Also, the filtering coefficients stored in the initial filtering coefficient storage unit 74 may be values other than 1/9, 2/9, 3/9, 2/9, and 1/9.

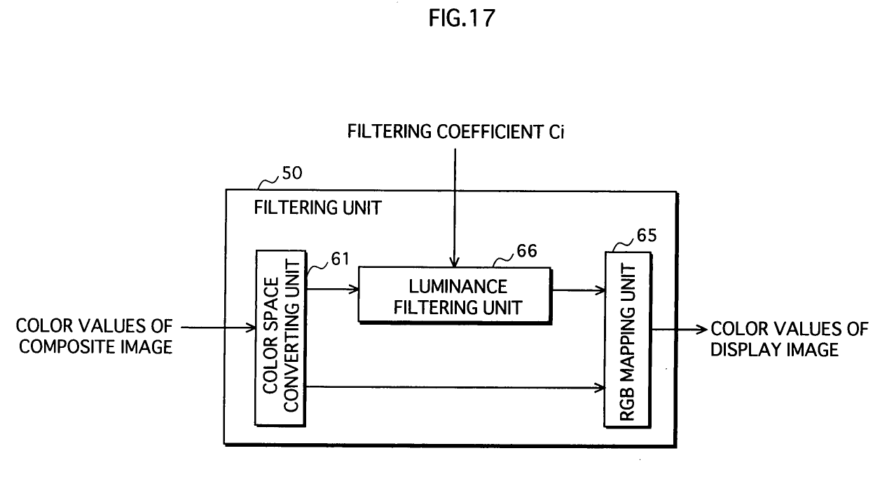

FIG. 17 shows the construction of the filtering unit 50. The filtering unit 50 differs from the filtering unit 45 in Embodiment 1 in that it omits the filtering coefficient storage unit 62 and has a luminance filtering unit 66 replacing the luminance filtering unit 63. With this construction, filtering coefficients output from the filtering coefficient interpolating unit 75 are used instead of the filtering coefficients stored in the filtering coefficient storage unit 62. The following is a description of the luminance filtering unit 66 that operates differently from the luminance filtering unit 63 in Embodiment 1.

The luminance filtering unit 66 includes a buffer for holding luminance values of five sub-pixels identified by internal processing coordinates (x′−2,y′), (x′−1,y′), (x′,y′), (x′+1,y′), (x′+2,y′) which align in the first direction, where the processing target is the sub-pixel at internal processing coordinates (x′,y′), and stores the luminance values of the composite image into the buffer in sequence as received from the color space conversion unit 61. The luminance filtering unit 66 also performs a filtering process for smoothing out the five luminance values stored in the buffer using the filtering coefficients output from the filtering coefficient interpolating unit 75, and calculates the luminance value of the target sub-pixel at internal processing coordinates (x′, y′). The luminance filtering unit 66 then outputs the post-filtering luminance value of the target sub-pixel to the RGB mapping unit 65. It should be noted here that both the luminance filtering units 63 and 66 perform the same filtering process.

In Embodiment 2, the color value and α value are used to detect a change in color in the front image. However, as is the case with Embodiment 1, other elements relating to visual characteristics such as color may be used to detect a change in color.

With the above-described construction of Embodiment 2, the display apparatus varies the degree of smooth-out effect by the filtering process according to the dissimilarity level of each sub-pixel to the surrounding sub-pixels in the front image. In contrast to a conventional technique that performs a filtering process to provide a constant degree of smooth-out effect to each sub-pixel of a composite image, the present embodiment provides a higher degree of smooth-out effect to a sub-pixel in a composite image that corresponds to a sub-pixel in a front image which is greatly different from surrounding sub-pixels in color value, and at the same time prevents a sub-pixel in a composite image that corresponds to a sub-pixel in a front image which is not so much different from surrounding sub-pixels in color value, from being excessively smoothed out. Furthermore, the present technique reduces the accumulation of the smooth-out effect in the back image component of the composite image.

Operation

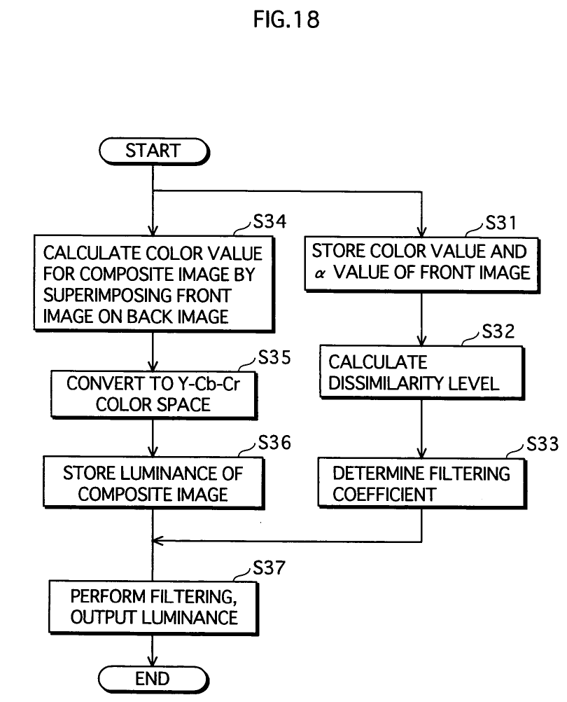

The operation of the display apparatus 200 will be described with reference to FIG. 18 in terms of operations procedures unique to the display apparatus 200, that is to say, from after the superimposing/sub-pixel processing unit 37 receives the color values and α value of the front image and the color values of the back image until the luminance filtering unit 66 outputs the luminance values to the RGB mapping unit 65.

FIG. 18 is a flowchart showing the operation procedures of the display apparatus 200 in Embodiment 2 for generating a composite image and performing a filtering process on the color values.

The color value storage unit 51 stores the color values and α value of the certain sub-pixel in the front image received from the texture mapping unit 33 (S31). As a result of this, the color value storage unit 51 currently stores color values and α values of five sub-pixels including the certain sub-pixel and four other sub-pixels that are adjacent to the certain sub-pixel in the first direction and have been processed prior to the certain sub-pixel. The color space distance calculating unit 52 calculates the Euclidean square distance in a color space including α values for each combination of the five sub-pixels identified whose values are stored in the color value storage unit 51. The largest color space distance selecting unit 53 selects the largest value among the Euclidean square distance values output from the color space distance calculating unit 52, and outputs the selected value to the filtering coefficient interpolating unit 75 (S32).

The filtering coefficient interpolating unit 75 determines a filtering coefficient for the target sub-pixel by performing a calculation on the initial values stored in the initial filtering coefficient storage unit 74 in accordance with the dissimilarity level received from the largest color space distance selecting unit 53, and outputs the determined filtering coefficient to a luminance filtering unit 66 of the filtering unit 50 (S33).

On the other hand, the superimposing unit 41 calculates a color value of the certain sub-pixel in a composite image from (a) the color values and the α value of the front image output from the texture mapping unit 33 and (b) the color values of the back image output from the back-image tripling unit 34 (S34), and outputs the calculated color values of the composite image sub-pixel to the color space conversion unit 61 of the filtering unit 50.

The color space conversion unit 61 converts the color values of the R-G-B color space received from the superimposing unit 41 into the values of the luminance, blue-color-difference, and red-color-difference of the Y-Cb-Cr color space, outputs the luminance values to the luminance filtering unit 66, and outputs the blue-color-difference value and the red-color-difference values to the RGB mapping unit 65 (S35).

The luminance filtering unit 66 stores the luminance value received from the color space conversion unit 61 into the buffer (S36). The buffer holds luminance values of five sub-pixels including the certain sub-pixel and four other sub-pixels that are adjacent to the certain sub-pixel in the first direction and have been processed prior to the certain sub-pixel. The luminance filtering unit 66 regards a sub-pixel at the center of the five sub-pixels as the target sub-pixel, and calculates the luminance value of the target sub-pixel by performing a filtering process in accordance with the filtering coefficient received from the filtering coefficient interpolating unit 75, and outputs the post-filtering luminance values of the target sub-pixel to the RGB mapping unit 65 (S37).

With the above-described operation, it is possible to reduce the accumulation of the smooth-out effect in the back image component of the composite image.

Not limited to Embodiments 1 and 2 described so far, the present invention can be applied to the following cases.

(1) The operation procedures of each component of the display apparatus explained in Embodiment 1 or 2 may be written into a computer program so as to be executed by a computer. Also, the computer program may be recorded in a record medium, such as a floppy disk, hard disk, IC card, optical disc, CD-ROM, DVD, or DVD-ROM, so that it can be distributed. Also, the computer program may be distributed via any communication paths.

(2) In Embodiments 1 and 2, both the front and back images are color images in the R-G-B format. However, the present invention can be applied to gray-scale images or color images in the Y-Cb-Cr format, as well.

(3) In both Embodiments 1 and 2, the filtering process is performed on the luminance component (Y) of the Y-Cb-Cr color space converted from the R-G-B color space. However, the present invention can be applied to the case where the filtering process is performed on each color (R, G, B) of the R-G-B color space, or to the case where the filtering process is performed on Cb or Cr of the Y-Cb-Cr color space.

(4) The filtering coefficients may be set to other values than 1/9, 2/9, 3/9, 2/9, and 1/9 which are disclosed in “Sub-Pixel Font Rendering Technology”. For example, a different filtering coefficient may be assigned to each color (R, G, B) of the luminous elements corresponding to the sub-pixels to be subject to the filtering process, in accordance with the degree of contribution of each color (R, G, B) to the luminance.

(5) The data stored in the buffers included in the components of Embodiments 1 and 2 may be stored in other places such as a partial area of a memory.

(6) The present invention may be achieved as any combinations of Embodiments 1 and 2 and the above cases (1) to (5).

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A display apparatus for displaying an image on a display device which includes rows of pixels, each pixel composed of three sub-pixels that align in a lengthwise direction of the pixel rows and emit light of three primary colors respectively, the display apparatus comprising:
a front image storage unit operable to store color values of sub-pixels that constitute a front image to be displayed on the display device;
a calculation unit operable to calculate a dissimilarity level of a target sub-pixel to one or more sub-pixels that are adjacent to the target sub-pixel in the lengthwise direction of the pixel rows, from color values of first-target-range sub-pixels composed of the target sub-pixel and the one or more adjacent sub-pixels stored in the front image storage unit;
a superimposing unit operable to generate, from color values of the front image stored in the front image storage unit and color values of an image currently displayed on the display device, color values of sub-pixels constituting a composite image of the front image and the currently displayed image;
a filtering unit operable to smooth out color values of second-target-range sub-pixels of the composite image that correspond to the first-target-range sub-pixels, by assigning weights, which are determined in accordance with the dissimilarity level, to the second-target-range sub-pixels; and
a displaying unit operable to display the composite image based on the color values thereof after the smoothing out.

2. The display apparatus of Claim 1, wherein
the calculation unit calculates a temporary dissimilarity level for each combination of the first-target-range sub-pixels, from color values of the first-target-range sub-pixels, and regards a largest temporary dissimilarity level among results of the calculation to be the dissimilarity level.

3. The display apparatus of Claim 2, wherein
the first-target-range sub-pixels and the second-target-range sub-pixels are identical with each other in number and positions in the display device.

4. The display apparatus of Claim 1, wherein
the filtering unit performs the smoothing out of the second-target-range sub-pixels if the dissimilarity level calculated by the calculation unit is greater than a predetermined threshold value, and does not perform the smoothing out if the calculated dissimilarity level is no greater than the predetermined threshold value.

5. A display apparatus for displaying an image on a display device which includes rows of pixels, each pixel composed of three sub-pixels that align in a lengthwise direction of the pixel rows and emit light of three primary colors respectively, the display apparatus comprising:
a front image storage unit operable to store color values and transparency values of sub-pixels that constitute a front image to be displayed on the display device, where the transparency values indicate degrees of transparency of sub-pixels of the front image when the front image is superimposed on an image currently displayed on the display device;
a calculation unit operable to calculate a dissimilarity level of a target sub-pixel to one or more sub-pixels that are adjacent to the target sub-pixel in the lengthwise direction of the pixel rows, from at least one of (i) color values and (ii) transparency values of first-target-range sub-pixels composed of the target sub-pixel and the one or more adjacent sub-pixels stored in the front image storage unit;
a superimposing unit operable to generate, from color values of the front image stored in the front image storage unit and color values of the image currently displayed on the display device, color values of sub-pixels constituting a composite image of the front image and the currently displayed image;
a filtering unit operable to smooth out color values of second-target-range sub-pixels of the composite image that correspond to the first-target-range sub-pixels, by assigning weights, which are determined in accordance with the dissimilarity level, to the second-target-range sub-pixels; and
a displaying unit operable to display the composite image based on the color values thereof after the smoothing out.

6. The display apparatus of Claim 5, wherein
the calculation unit calculates a temporary dissimilarity level for each combination of the first-target-range sub-pixels, from at least one of (i) color values and (ii) transparency values of the first-target-range sub-pixels, and regards a largest temporary dissimilarity level among results of the calculation to be the dissimilarity level.

7. The display apparatus of Claim 6, wherein
the first-target-range sub-pixels and the second-target-range sub-pixels are identical with each other in number and positions in the display device.

8. The display apparatus of Claim 5, wherein
the filtering unit performs the smoothing out of the second-target-range sub-pixels if the dissimilarity level calculated by the calculation unit is greater than a predetermined threshold value, and does not perform the smoothing out if the calculated dissimilarity level is no greater than the predetermined threshold value.

9. A display method for displaying an image on a display device which includes rows of pixels, each pixel composed of three sub-pixels that align in a lengthwise direction of the pixel rows and emit light of three primary colors respectively, the display method comprising:
a front image acquiring step for acquiring color values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device;
a calculation step for calculating a dissimilarity level of the target sub-pixel to the one or more sub-pixels, from the color values of the first-target-range sub-pixels acquired in the front image acquiring step;
a superimposing step for generating, from the color values of the front image acquired in the front image acquiring step and color values of an image currently displayed on the display device, color values of sub-pixels constituting a composite image of the front image and the currently displayed image;
a filtering step for smoothing out color values of second-target-range sub-pixels of the composite image that correspond to the first-target-range sub-pixels, by assigning weights, which are determined in accordance with the dissimilarity level, to the second-target-range sub-pixels; and
a displaying step for displaying the composite image based on the color values thereof after the smoothing out.

10. A display method for displaying an image on a display device which includes rows of pixels, each pixel composed of three sub-pixels that align in a lengthwise direction of the pixel rows and emit light of three primary colors respectively, the display method comprising:
a front image acquiring step for acquiring color values and transparency values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device, where the transparency values indicate degrees of transparency of sub-pixels of the front image when the front image is superimposed on an image currently displayed on the display device;
a calculation step for calculating a dissimilarity level of the target sub-pixel to the one or more sub-pixels, from at least one of the (i) color values and (ii) transparency values of the first-target-range sub-pixels acquired in the front image acquiring step;
a superimposing step for generating, from the color values of the front image acquired in the front image acquiring step and color values of the currently displayed image, color values of sub-pixels constituting a composite image of the front image and the currently displayed image;
a filtering step for smoothing out color values of second-target-range sub-pixels of the composite image that correspond to the first-target-range sub-pixels, by assigning weights, which are determined in accordance with the dissimilarity level, to the second-target-range sub-pixels; and
a displaying step for displaying the composite image based on the color values thereof after the smoothing out.

11. A display program for displaying an image on a display device which includes rows of pixels, each pixel composed of three sub-pixels that align in a lengthwise direction of the pixel rows and emit light of three primary colors respectively, the display program causing a computer to execute:
a front image acquiring step for acquiring color values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device;
a calculation step for calculating a dissimilarity level of the target sub-pixel to the one or more sub-pixels, from the color values of the first-target-range sub-pixels acquired in the front image acquiring step;
a superimposing step for generating, from the color values of the front image acquired in the front image acquiring step and color values of an image currently displayed on the display device, color values of sub-pixels constituting a composite image of the front image and the currently displayed image;
a filtering step for smoothing out color values of second-target-range sub-pixels of the composite image that correspond to the first-target-range sub-pixels, by assigning weights, which are determined in accordance with the dissimilarity level, to the second-target-range sub-pixels; and
a displaying step for displaying the composite image based on the color values thereof after the smoothing out.

12. A display program for displaying an image on a display device which includes rows of pixels, each pixel composed of three sub-pixels that align in a lengthwise direction of the pixel rows and emit light of three primary colors respectively, the display program causing a computer to execute:
a front image acquiring step for acquiring color values and transparency values of first-target-range sub-pixels composed of a target sub-pixel and one or more sub-pixels that are adjacent to the target sub-pixel in the lengthwise direction of the pixel rows, the first-target-range sub-pixels are included in sub-pixels that constitute a front image to be displayed on the display device, where the transparency values indicate degrees of transparency of sub-pixels of the front image when the front image is superimposed on an image currently displayed on the display device;
a calculation step for calculating a dissimilarity level of the target sub-pixel to the one or more sub-pixels, from at least one of the (i) color values and (ii) transparency values of the first-target-range sub-pixels acquired in the front image acquiring step;
a superimposing step for generating, from the color values of the front image acquired in the front image acquiring step and color values of the currently displayed image, color values of sub-pixels constituting a composite image of the front image and the currently displayed image;
a filtering step for smoothing out color values of second-target-range sub-pixels of the composite image that correspond to the first-target-range sub-pixels, by assigning weights, which are determined in accordance with the dissimilarity level, to the second-target-range sub-pixels; and
a displaying step for displaying the composite image based on the color values thereof after the smoothing out.
